(19) United States
(12) Patent Application Publication
(10) Pub. No.: US 2020/0058432 A1
(43) Pub. Date: Feb. 20, 2020

(54) Frame Device Of Iron Core Of Static Electrical Machine Having Outwardly-Extended Heat Dissipation Fin And/Or Heat Dissipation Hole

(71) Applicant: Tai-Her Yang, Dzan-Hwa (TW)

(72) Inventor: Tai-Her Yang, Dzan-Hwa (TW)

(21) Appl. No.: 16/542,853

(22) Filed: Aug. 16, 2019

Related U.S. Application Data
(63) Continuation-in-part of application No. 16/104,300, filed on Aug. 17, 2018.

(51) Int. Cl. H01F 27/08; H01F 27/26; H01F 27/28; F28F 13/06

(52) U.S. Cl. CPC H01F 27/08; H01F 27/263; H02K 9/22; F28F 13/06; H01F 27/28

(57) ABSTRACT

The present invention discloses a frame device of iron core of static electrical machine having outwardly-extended heat dissipation fin and/or heat dissipation hole, in which a frame device is formed with an outwardly-extended heat dissipation fin structure and/or formed with heat dissipation holes at locations defined on adjacent surfaces between the frame device and an iron core with magnetic loops, so that the heat dissipation hole can be served to enlarge the heat dissipation area, directly exposed to an ambient gaseous or liquid environment, of the iron core with the magnetic loops of a static electrical machine, and the outwardly-extended heat dissipation fin structure can be served to enlarge the heat dissipation area to the exterior, thereby allowing the heat dissipation performance of the iron core with the magnetic loops, clamped and fastened by the frame device, to the gaseous or liquid environment to be further enhanced.

### CROSS REFERENCE TO RELATED APPLICATION

This is a Continuation-In-Part of application Ser. No. 16/104,300, filed on Aug. 17, 2018.

### BACKGROUND OF THE INVENTION

### (a) Field of the Invention

The present invention discloses a frame device of iron core of static electrical machine having outwardly extended heat dissipation fin and/or heat dissipation hole, which can be applied in a winding structure consisted of a coil winding set, a BOBBIN, conducting pins and leading wires or a static electrical machine and consisted of an iron core with magnetic loops and installed in a gaseous or a liquid working environment, such as a transformer, an inductor, an electromagnet or a linear displacing actuator adopting the electromagnetic effect, or a device adopting the electromagnetic effect such as a device capable of converting kinetic energy generated via linear and reciprocal displacements into electrical energy for power generation, thereby enhancing the heat dissipation performances of the above-mentioned structures and devices; in the above-mentioned application devices adopting the electromagnetic effect, the iron core with the magnetic loops is often fastened in a frame device made of a heat conducive material so as to be easily assembled or disassembled, the above-mentioned frame device where the iron core with the magnetic loops being disposed therein would shield a surface of the iron core with the magnetic loops which is served to dissipate heat to the exterior, so that a multi-layered structure formed through the above-mention components and devices would generate a greater thermal resistance for the heat transmission, and the heat transmission and the heat dissipation to the exterior performed by the iron core with the magnetic loops would be obstructed, thereby deteriorating the heat dissipation performance.

Instead of being applied in a revolving electrical machine which generates revolving kinetic power, the frame device of iron core of static electrical machine having outwardly-extended heat dissipation fin and/or heat dissipation hole provided by the present invention is aimed to be applied in a frame device which is served to clamp and fasten the outer periphery of the iron core with the magnetic loops of an application device adopting the electromagnetic effect and disposed in a static electrical machine, the frame device disclosed in the frame device of iron core of static electrical machine having outwardly-extended heat dissipation fin and/or heat dissipation hole is:formed with an outwardly-extended heat dissipation fin structure and/or formed with heat dissipation holes at locations defined on adjacent surfaces between the frame device and the iron core with the magnetic loops, so that the heat dissipation hole can be served to enlarge the heat dissipation area, directly exposed to an ambient gaseous or liquid environment, of the iron core with the magnetic loops of the static electrical machine, and the outwardly-extended heat dissipation fin can be served to enlarge the heat dissipation area to the exterior, thereby allowing the heat dissipation performance of the iron core with the magnetic loops, clamped and fastened by the frame device, to the ambient gaseous or liquid environment to be further enhanced.

### (b) Description of the Prior Art

In a conventional winding structure consisted of a coil winding set, a BOBBIN, conducting pins and leading wires or an application device adopting the electromagnetic effect and consisted of an iron core with magnetic loops and allowing the magnetic flux to pass, for example a static electrical machine such as a transformer, an inductor, an actuator adopting the electromagnetic effect, an electromagnet or an application device adopting the electromagnetic effect such as a device capable of converting kinetic energy generated via displacements into electrical energy for power generation, a frame device made of a heat conducive material is often adopted for fastening, the advantage thereof is that the iron core with the magnetic loops of the electromagnetic application device can be effectively fastened and the winding structure consisted of the coil winding set, the BOBBIN, the conducting pins and the leading wires can be protected, but the disadvantage is that the heat dissipation area of the iron core which is served to dissipate heat to the exterior would be significantly shielded by the frame device, so that the heat dissipation performance of the electromagnetic application device which is served to dissipate heat to the exterior is deteriorated

### SUMMARY OF THE INVENTION

It is known that a static electrical machine and a revolving electrical machine are different, the static electrical machine is not provided with a self-revolving function, so that the static electrical machine is unable to drive a cooling fan for assisting the cooling operation like a rotation member formed on a main body of the revolving electrical machine; thus, the raised temperature is a serious problem for the static electrical machine, a severe situation would be the whole electrical machine is broken and a minor situation would is the operation efficiency is decreased, so that it is extremely important for the static electrical machine to be provided with an excellent heat dissipation performance; based on the considerations of the occupied space, the weight and the production cost, one major issue to be solved by the skilled people in the art is to develop a novel heat dissipation performance with lower production cost, smaller volume and capable of assisting the static electrical machine to dissipate heat with a radiating, conducting or convecting means without being additionally provided with a cooling fan or a liquid cooling device;

In a conventional winding structure consisted of a coil winding set, a BOBBIN, conducting pins and leading wires or an application device adopting the electromagnetic effect and consisted of an iron core with magnetic loops and allowing the magnetic flux to pass, for example a static electrical machine such as a transformer, an inductor, an actuator adopting the electromagnetic effect, an electromagnet or an application device adopting the electromagnetic effect such as a device capable of converting kinetic energy generated via displacements into electrical energy for power generation, a frame device made of a beat conducive material is often adopted for fastening, the advantage thereof is that the iron core with the magnetic loops of the electromagnetic application device can be effectively fastened and the winding structure consisted of the coil winding set, the BOBBIN, the conducting pins and the leading wires can be protected, but the disadvantage is that the heat dissipation area of the iron core which is served to dissipate heat to the exterior would be significantly shielded by the frame device, so that the heat dissipation performance of the electromagnetic application device which is served to dissipate heat to the exterior is deteriorated;

Instead of being applied in a revolving electrical machine which generates revolving kinetic power, the frame device of iron core of static electrical machine having outwardly-extended heat dissipation fin and/or heat dissipation hole provided by the present invention is aimed to be applied in a frame device which is served to clamp and fasten the outer periphery of the iron core with the magnetic loops of an application device adopting the electromagnetic effect and disposed in a static electrical machine, the frame device disclosed in the frame device of iron core of static electrical machine having outwardly-extended heat dissipation fin and/or heat dissipation hole is formed with an outwardly-extended heat dissipation fin structure and/or formed with heat dissipation holes at locations defined on adjacent surfaces between the frame device and the iron core with the magnetic loops, so that the heat dissipation hole can be served to enlarge the heat dissipation area, directly exposed to an ambient gaseous or liquid environment, of the iron core with the magnetic loops of the static electrical machine, and the outwardly-extended heat dissipation fin can be served to enlarge the heat dissipation area to the exterior, thereby allowing the heat dissipation performance of the iron core with the magnetic loops, clamped and fastened by the frame device, to the ambient gaseous or liquid environment to be further enhanced.

### BRIEF DESCRIPTION OF THE DRAWINGS

FIG. 1 is a schematic view showing locations where the outwardly-extended heat dissipation fins and/or the heat dissipation holes being formed on a top surface (E) of the frame device (200) of the iron core with the magnetic loops (300) of the static electrical machine according to the present invention.

FIG. 2 is a schematic view showing locations where the outwardly-extended heat dissipation fins and/or the heat dissipation holes being formed on front surfaces (A, B, C, D) of the frame device (200) of the iron core with the magnetic loops (300) of the static electrical machine according to the present invention.

FIG. 3 is a schematic view showing locations where the outwardly-extended heat dissipation fins and/or the heat dissipation holes being formed on a left surface (F) of the frame device (200) of the iron core with the magnetic loops (300) of the static electrical machine according to the present invention.

FIG. 4 is a schematic view showing locations where the outwardly-extended heat dissipation fins and/or the heat dissipation holes being formed on a right surface (G) of the frame device (200) of the iron core with the magnetic loops (300) of the static electrical machine according to the present invention.

FIG. 5 is a schematic view showing locations where the outwardly-extended heat dissipation fins and/or the heat dissipation holes being formed on rear surfaces I, J, K, L) of the frame device (200) of the iron core with the magnetic loops (300) of the static electrical machine according to the present invention.

FIG. 6 is a schematic view showing locations where the outwardly-extended heat dissipation fins and/or the heat dissipation holes being formed on a bottom surface (H) of the frame device (200) of the iron core with the magnetic loops (300) of the static electrical machine according to the present invention.

FIG. 7 is a front view showing the frame device (200) being formed with at least one transversal (X-X) bridge-type heat dissipation fin (101) and an adjacent transversal (X-X) jointly-formed heat dissipation hole (111) according to a first embodiment of the present invention.

FIG. 8 is a top view of FIG. 7.

FIG. 9 is a side view of FIG. 7.

FIG. 10 is a front view showing the frame device (200) being formed with at least one longitudinal (Y-Y) bridge-type heat dissipation fin (102) and an adjacent longitudinal (Y-Y) jointly-formed heat dissipation hole (112) according to a second embodiment of the present invention.

FIG. 11 is a top view of FIG. 10.

FIG. 12 is a side view of FIG. 10.

FIG. 13 is a front view showing the frame device (200) being formed with a plurality of the transversal (X-X) bridge-type heat dissipation fins (101) and the adjacent transversal (X-X) jointly-formed heat dissipation holes (111) according to a third embodiment of the present invention.

FIG. 14 is a top view of FIG. 13.

FIG. 15 is a side view of FIG. 13.

FIG. 16 is a front view showing the frame device (200) being formed with a plurality of the longitudinal (Y-Y) bridge-type heat dissipation fins (102) and the adjacent longitudinal (Y-Y) jointly-formed heat dissipation holes (1.12) according to a fourth embodiment of the present invention.

FIG. 17 is a top view of FIG. 16.

FIG. 18 is a side view of FIG. 16.

FIG. 19 is a front view showing the frame device (200) being formed with the transversal (X-X) bridge-type heat dissipation fins (101) and the adjacent transversal (X-X) jointly-formed heat dissipation holes (111), and the transversal (X-X) bridge-type heat dissipation fins (101) being respectively formed with at least one flow discharging hole (120) according to a fifth embodiment of the present invention.

FIG. 20 is a top view of FIG. 19.

FIG. 21 is a side view of FIG. 19.

FIG. 22 is a front view showing the frame device (200) being formed with the longitudinal (Y-Y) bridge-type heat dissipation fins (102) and the adjacent longitudinal (Y-Y) jointly-formed heat dissipation holes (112), and the longitudinal (Y-Y) bridge-type heat dissipation fins (102) being respectively formed with the at least one flow discharging hole (120) according to a sixth embodiment of the present invention.

FIG. 23 is a top view of FIG. 22.

FIG. 24 is a side view of FIG. 22.

FIG. 25 is a front view showing the frame device (200) being formed with at least one inclined bridge-type heat dissipation fin (106) and an adjacent inclined jointly-formed heat dissipation hole (116) according to a seventh embodiment of the present invention.

FIG. 26 is a top view of FIG. 25.

FIG. 27 is a side view of FIG. 25.

FIG. 28 is a front view showing the frame device (200) being formed with at least one V-shaped bridge-type heat dissipation fin (107) and an adjacent V-shaped jointly-formed heat dissipation hole (117) according to an eighth embodiment of the present invention.

FIG. 29 is a top view of FIG. 28.

FIG. 30 is a side view of FIG. 28.

FIG. 31 is a front view showing the frame device (200) being formed with a plurality of transversal (X-X) semi-bridge-type heat dissipation fins (104) and the adjacent transversal (X-X) jointly-formed heat dissipation holes (111) according to a ninth embodiment of the present invention,

FIG. 32 is a top view of FIG. 31.

FIG. 33 is a side view of FIG. 31.

FIG. 34 is a front view showing the frame device (200) being formed with a plurality of longitudinal (Y-Y) semi-bridge-type heat dissipation fins (105) and the adjacent longitudinal (Y-Y) jointly-formed heat dissipation holes (112) according to a tenth embodiment of the present invention.

FIG. 35 is a top view of FIG. 34.

FIG. 36 is a side view of FIG. 34,

FIG. 37 is a schematic view showing the frame device (200) being formed with the transversal (X-X) semi-bridge-type heat dissipation fins (104) arranged at the same side and the adjacent transversal (X-X) jointly-formed heat dissipation holes (111) according to one embodiment of the present invention.

FIG. 38 is a schematic view showing the frame device (200) being formed with the transversal (X-X) semi-bridge-type heat dissipation fins (104) staggeringly arranged at different sides and the adjacent transversal (X-X) jointly-formed heat dissipation holes (111) according to one embodiment of the present invention.

FIG. 39 is a front view showing the frame device (200) being formed with the at least one transversal (X-X) semi-bridge-type heat dissipation fins (104) arranged at the same side and as multiple rows and the adjacent transversal (X-X) jointly-formed heat dissipation holes (111) according to an eleventh embodiment of the present invention.

FIG. 40 is a top view of FIG. 39.

FIG. 41 is a side view of FIG. 39.

FIG. 42 is a front view showing the frame device (200) being formed the at least one transversal (X-X) semi-bridge-type heat dissipation fin (104) arranged at different sides and as multiple rows and the adjacent transversal (X-X) jointly-formed heat dissipation holes (111) according to a twelfth embodiment of the present invention.

FIG. 43 is a top view of FIG. 42.

FIG. 44 is a side view of FIG. 42.

FIG. 45 is a front view showing at least one of outer edges of the adjacent surfaces between the frame device (200) and the iron core of the static electrical machine being formed with an outwardly-bent-from-outer-edge heat dissipation fin (103) according to a thirteenth embodiment of the present invention.

FIG: 46 is a top view of FIG. 45.

FIG. 47 is a side view of FIG. 45,

FIG. 48 is a front view showing at least one of the outer edges of the adjacent surfaces between the frame device (200) and the iron core of the static electrical machine being formed with the outwardly-bent-from-outer-edge heat dissipation fin (103) in a multi-bending structural status according to a fourteenth embodiment of the present invention.

FIG. 49 is a top view of FIG. 48.

FIG. 50 is a side view of FIG. 48.

FIG. 51 is a front view showing the frame device (200) being formed with the longitudinal (Y-Y) bridge-type heat dissipation fins (102) and the adjacent longitudinal (Y-Y) jointly-formed heat dissipation holes (112), and at least one of the outer edges of the adjacent surfaces between the frame device (200) and the iron core of the static electrical machine being formed with the outwardly-bent-from-outer-edge heat dissipation fin (103) in a multi-bending structural status according to a fifteenth embodiment of the present invention.

FIG. 52 is a top view of FIG. 51.

FIG. 53 is a side view of FIG. 51.

FIG. 54 is a front view showing the frame device (200) being formed with the longitudinal (Y-Y) bridge-type heat dissipation fins (102) and the adjacent longitudinal (Y-Y) jointly-formed heat dissipation holes (112), the longitudinal (Y-Y) bridge-type heat dissipation fins (102) being respectively formed with the at least one flow discharging hole (120), and at least one of the outer edges of the adjacent surfaces between the frame device (200) and the iron core of the static electrical machine being formed with the outwardly-bent-from-outer-edge heat dissipation fin (103) in a multi-bending structural status according to a sixteenth embodiment of the present invention.

FIG. 55 is a top view of FIG. 54.

FIG. 56 is a side view of FIG. 54.

FIG. 57 is a front view showing at least one of the adjacent surfaces between the frame device (200) of the iron core of the static electrical machine and the iron core with the magnetic loops (300) being formed with a rectangular heat dissipation hole (130) allowing the iron core with the magnetic loops (300) to directly dissipate heat to the exterior according to one embodiment of the present invention.

FIG. 58 is a top view of FIG. 57.

FIG. 59 is a side view of FIG. 57.

FIG. 60 is a schematic view showing various shapes applicable to the jointly-formed adjacent transversal (X-X) heat dissipation hole (111), the jointly-formed adjacent longitudinal (Y-Y) heat dissipation hole (112), the jointly-formed adjacent inclined heat dissipation hole (116), the adjacent T-shaped jointly-formed heat dissipation hole (117) and the heat dissipation hole (130) formed on the adjacent surfaces between the frame device (200) of the iron core of the static electrical machine and the iron core with the magnetic loops (300) and allowing the iron core with the magnetic loops (300) to directly dissipate heat to the exterior according to one embodiment of the present invention.

FIG. 61 is a front view showing the frame device (200) being formed with the transversal (X-X) bridge-type heat dissipation fins (101) and the adjacent transversal (X-X) jointly-formed heat dissipation holes (111), the transversal (X-X) bridge-type heat dissipation fins (101) being respectively formed with the at least one flow discharging hole (120), and the adjacent surfaces between the frame device (200) and the iron with the magnetic loops (300) being formed with the heat dissipation holes (130) allowing the iron core with the magnetic loops (300) to directly dissipate heat to the exterior according to a seventeenth embodiment of the present invention.

FIG. 62 is a top view of FIG. 61.

FIG. 63 is a side view of FIG. 61.

FIG. 64 is a front view showing the frame device (200) being formed with the longitudinal (Y-Y) bridge-type heat dissipation fins (102) and the adjacent longitudinal (Y-Y) jointly-formed heat dissipation holes (112), the longitudinal (Y-Y) bridge-type heat dissipation fins (102) being respectively formed with the at least one flow discharging hole (120), and the adjacent surfaces between the frame device (200) and the iron with the magnetic loops (300) being formed with the heat dissipation holes (130) allowing the iron core with the magnetic loops (300) to directly dissipate heat to the exterior according to an eighteenth embodiment of the present invention.

FIG. 65 is a top view of FIG. 64.

FIG. 66 is a side view of FIG. 64.

FIG. 67 is a front view showing the frame device (200) being formed with the at least one transversal (X-X) semi-bridge-type heat dissipation fin (104) and the adjacent transversal (X-X) jointly-formed heat dissipation hole (111), and the adjacent surfaces between the frame device (200) and the iron with the magnetic loops (300) being formed with the heat dissipation hole (130) allowing the iron core with the magnetic loops (300) to directly dissipate heat to the exterior according to a nineteenth embodiment of the present invention.

FIG. 68 is a top view of FIG. 67,

FIG. 69 is a side view of FIG. 67.

FIG. 70 is a front view showing the frame device (200) being formed with the at least one longitudinal (Y-Y) semi-bridge-type heat dissipation fin (105) and the adjacent longitudinal (Y-Y) jointly-formed heat dissipation hole (112), and the adjacent surfaces between the frame device (200) and the iron with the magnetic loops (300) being formed with the heat dissipation hole (130) in a rectangular slot-life status and allowing the iron core with the magnetic loops (300) to directly dissipate heat to the exterior according to a twentieth embodiment of the present invention.

FIG. 71 is a top view of FIG. 70,

FIG. 72 is a side view of FIG. 70.

FIG. 73 is a front view showing the frame device (200) wherein at least one surface of the frame device is being formed with multi-row at least one of longitudinal (Y-Y) or near inclined longitudinal (Y-Y) adjacently arranged eddy-current blocking structure (1120) which consist of at least one perforated slots or long grooves fabricate in longitudinal (Y-Y) or inclined longitudinal (Y-Y) orientation according to a twenty first embodiment of the present invention.

FIG. 74 is a top view of FIG. 73.

FIG. 75 is a side view of FIG. 73,

FIG. 76 is a bottom view of FIG. 73.FIG 77 is a front view showing the frame device (200) wherein at least one surface of the frame device is being formed with at least one transversal (X-X) or inclined transversal (X-X) arranged eddy-current blocking structure (1110) which consist of at least one perforated slot or long groove fabricate in transversal (X-X) or inclined transversal (X-X) orientation according to a twenty second embodiment of the present invention.

FIG. 78 is a top view of FIG. 77.

FIG. 79 is a side view of FIG. 77.

FIG. 80 is a bottom view of FIG. 77.

### DESCRIPTION OF MAIN COMPONENTS SYMBOLS

101: Transversal (X-X) bridge-type heat dissipation fin
102: Longitudinal (Y-Y) bridge-type heat dissipation fin
103: Outwardly-bent-from-outer-edge heat dissipation fin
104: Transversal (X-X) semi-bridge-type heat dissipation fin.
105: Longitudinal (Y-Y) semi-bridge-type heat dissipation fin
106: Inclined bridge-type heat dissipation fin
107: V-shaped bridge-type heat dissipation fin
111: Transversal (X-X) jointly-formed heat dissipation hole
112: Longitudinal (Y-Y) jointly-formed heat dissipation hole
116: Inclined jointly-formed heat dissipation hole
117: V-shaped jointly-formed heat dissipation hole
120: Flow discharging hole
130: Heat dissipation hole
200: Frame device
300: Iron core with magnetic loops
400: Winding set structure
1110, 1120: Eddy current blocking structure
B: Top surface of frame device
A, B, C, Front surface of frame device
F: Left surface of frame device
G: Right surface of frame device
K, L: Rear surface of frame device
H: Bottom surface of frame device

### DETAILED DESCRIPTION OF THE PREFERRED EMBODIMENTS

In a conventional winding structure consisted of a coil winding set, a BOBBIN, conducting pins and leading wires or an application device adopting the electromagnetic effect and consisted of an iron core with magnetic loops and allowing the magnetic flux to pass, for example a static electrical machine such as a transformer, an inductor, an actuator adopting the electromagnetic effect, an electromagnet or an application device adopting the electromagnetic effect such as a device capable of converting kinetic energy generated via displacements into electrical energy for power generation, a frame device made of a heat conducive material is often adopted for fastening, the advantage thereof is that the iron core with the magnetic loops of the electromagnetic application device can be effectively fastened and the winding structure consisted of the coil winding set, the BOBBIN, the conducting pins and the leading wires can be protected, but the disadvantage is that the heat dissipation area of the iron core which is served to dissipate heat to the exterior would be significantly shielded by the frame device, so that the heat dissipation performance of the electromagnetic application device which is served to dissipate heat to the exterior is deteriorated.

The present invention discloses a frame device of iron core of static electrical machine having outwardly-extended heat dissipation fin and/or heat dissipation hole, which can be applied in a winding structure consisted of a coil winding set, a BOBBIN, conducting pins and leading wires or a static electrical machine and consisted of an iron core with magnetic loops and installed in a gaseous or a liquid working environment, such as a transformer, an inductor, an electromagnet or a linear displacing actuator adopting the electromagnetic effect, or a device adopting the electromagnetic effect such as a device capable of converting kinetic energy generated via linear and reciprocal displacements into electrical energy for power generation, thereby enhancing the heat dissipation performances of the above-mentioned structures and devices; in the above-mentioned application devices adopting the electromagnetic effect, the iron core with the magnetic loops is often fastened in a frame device made of a heat conducive material so as to be easily assembled or disassembled, the above-mentioned frame device where the iron core with the magnetic loops being disposed therein would shield a surface of the iron core with the magnetic loops which is served to dissipate heat to the exterior, so that a multi-layered structure formed through the above-mention components and devices would generate a greater thermal resistance for the heat transmission, and the heat transmission and the heat dissipation to the exterior performed by the iron core with the magnetic loops would be obstructed, thereby deteriorating the heat dissipation performance.

Instead of being applied in a revolving electrical machine which generates revolving kinetic power, the frame device of iron core of static electrical machine having outwardly-extended heat dissipation fin and/or heat dissipation hole provided by the present invention is aimed to be applied in a frame device which is served to clamp and fasten the outer periphery of the iron core with the magnetic loops of an application device adopting the electromagnetic effect and disposed in a static electrical machine, the frame device disclosed in the frame device of iron core of static electrical machine having outwardly-extended heat dissipation fin and/or heat dissipation hole is formed with an outwardly-extended heat dissipation fin structure and/or formed with heat dissipation holes at locations defined on adjacent surfaces between the frame device and the iron core with the magnetic loops, so that the heat dissipation hole can be served to enlarge the heat dissipation area, directly exposed to an ambient gaseous or liquid environment, of the iron core with the magnetic loops of the static electrical machine, and the outwardly-extended heat dissipation fin can be served to enlarge the heat dissipation area to the exterior, thereby allowing the heat dissipation performance of the iron core with the magnetic loops, clamped and fastened by the frame device, to the ambient gaseous or liquid environment to be further enhanced.

The applicable devices of the present invention are application devices adopting the electromagnetic effect and clamped and fastened in a static electrical machine, such as a transformer, an inductor, an actuator adopting the electromagnetic effect, an electromagnet or a device capable of converting kinetic energy generated via displacements into electrical energy for power generation, the structural appearance thereof is often formed as a three-dimensional polygonal iron core with magnetic loops (300) consisted of sheet-like iron cores with magnetic loops (300) being mutually stacked, or formed with various three-dimensional shapes through sintering block-shaped magnetic conductive powder cores.

According to the present invention, a frame device (200) served to clamp and fasten the iron core with the magnetic loops (300), which is widely used and has six surfaces at the outer periphery thereof and formed as a square-like member or a rectangular member and adopted as the iron core of the static electrical machine, is provided as an example, the above-mentioned arrangement is to disclose arranged locations of outwardly-extended heat dissipation fin structures and/or arranged locations of heat dissipation holes formed on adjacent surfaces between the frame device (200) and the iron core with the magnetic loops (300). Detailed illustrations are provided as followings:

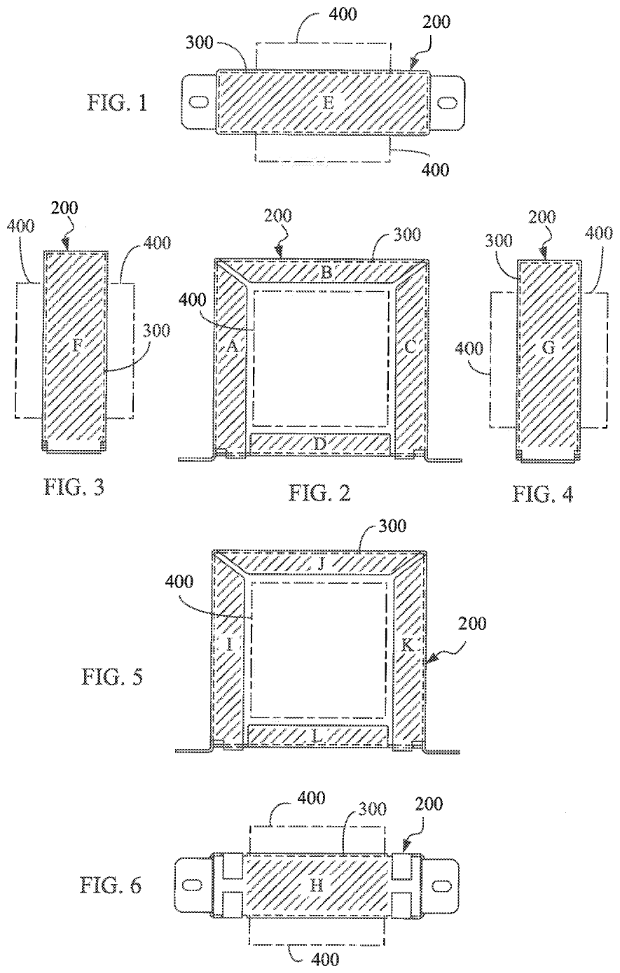

FIG. 1 is a schematic view showing locations where the outwardly-extended heat dissipation fins and/or the heat dissipation holes being formed on a top surface (E) of the frame device (200) of the iron core with the magnetic loops (300) of the static electrical machine according to the present invention.

FIG. 2 is a schematic view showing locations where the outwardly-extended heat dissipation fins and/or the heat dissipation holes being formed on front surfaces (A, B, C, D) of the frame device (200) of the iron core with the magnetic loops (300) of the static electrical machine according to the present invention.

FIG. 3 is a schematic view showing locations where the outwardly-extended heat dissipation fins and/or the heat dissipation holes being formed on a left surface (F) of the frame device (200) of the iron core with the magnetic loops (300) of the static electrical machine according to the present invention.

FIG. 4 is a schematic view showing locations where the outwardly-extended heat dissipation fins and/or the heat dissipation holes being formed on a right surface (G) of the frame device (200) of the iron core with the magnetic loops (300) of the static electrical machine according to the present invention.

FIG. 5 is a schematic view showing locations where the outwardly-extended heat dissipation fins and/or the heat dissipation holes being formed on rear surfaces (I, J, K, L) of the frame device (200) of the iron core with the magnetic loops (300) of the static electrical machine according to the present invention.

FIG. 6 is a schematic view showing locations where the outwardly-extended heat dissipation fires and/or the heat dissipation holes being formed on a bottom surface (H) of the frame device (200) of the iron core with the magnetic loops (300) of the static electrical machine according to the present invention.

As shown from FIG. I to FIG. 6, when the present invention is applied for clamping and fastening the iron core with the magnetic loops (300) formed as the square-like member or the rectangular member, the locations where the outwardly-extended heat dissipation fins and/or the heat dissipation holes (130) being desirably formed are at least one of the locations defined on the top surface, the front surfaces, the left surface, the right surface, the rear surfaces and bottom surface A, B, C, D, E, F, G, H, I, J, K, L, which are defined as the surfaces of the frame device (200) served to clamp and fasten the iron core with the magnetic loops (300);

When the frame device (200) is served for provide an external locking function to the static electrical machine, the bottom thereof is combined with a fastening surface, the bottom surface is inevitably shielded by the fastening surface, so that the outwardly-extended heat dissipation fins and/or the heat dissipation holes (300) can be optionally and flexibly formed, and at least one of the other surfaces of the frame device (200) is formed the outwardly-extended heat dissipation fins and/or the heat dissipation holes (300).

When the static electrical machine is in a suspended status, at least one of each surface of casing members of each surface of the frame device (200) served to clamp and fasten the iron core with the magnetic loops (300) of the static electrical machine is formed with the outwardly-extended heat dissipation fins and/or the heat dissipation holes (300).

As what is mentioned above, the characteristic of the frame device of iron core of static electrical machine having outwardly-extended heat dissipation fin and/or heat dissipation hole provided by the present invention is that the frame device (200) formed with the outwardly-extended heat dissipation fin and/or the heat dissipation hole (300) allowing heat to the directly dissipate to the exterior is able to configure an optimized structure for enhancing the heat transferring performance of the iron core with the magnetic loops (300) to the ambient gaseous or liquid environment, wherein:

the outwardly-extended heat dissipation fin and the heat dissipation hole includes one or more than one of the followings:
(1) transversal (X-X) bridge-type heat dissipation fin. 01);
(2) longitudinal (Y-Y) bridge-type heat dissipation fin (102);
(3) outwardly-bent-from-outer-edge heat dissipation fin (103);
(4) transversal (X-X) semi-bridge-type heat dissipation fin (104);
(5) longitudinal (Y-Y) semi-bridge-type heat dissipation fin (105);
(6) inclined bridge-type heat dissipation fin (106);
(7) V-shaped bridge-type heat dissipation fin (107);
(8) transversal X-X) jointly-formed heat dissipation hole (111);
(9) longitudinal (Y-Y) jointly-formed heat dissipation hole (112);
(10) inclined jointly-formed heat dissipation hole (116);
(11) V-shaped jointly-formed heat dissipation hole (117); and
(12) heat dissipation hole (130) formed on the adjacent surfaces between the frame device (200) and the iron core with the magnetic loops (300) and allowing the iron core with the magnetic loops (300) to directly dissipate heat to the exterior.

FIG. 7 is a front view showing the frame device (200) being formed with at least one transversal (X-X) bridge-type heat dissipation fin (101) and an adjacent transversal (X-X) jointly-formed heat dissipation hole (111) according to the first embodiment of the present invention.

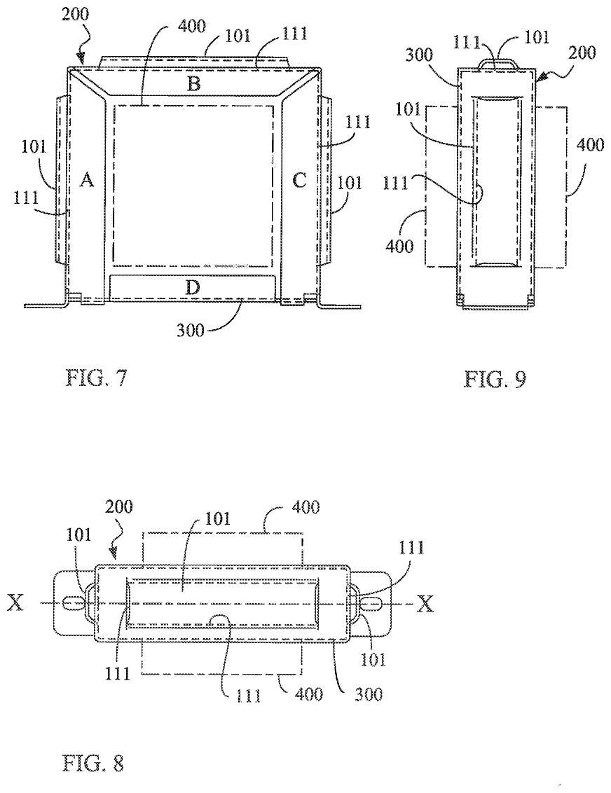

FIG. 8 is a top view of FIG. 7.

FIG. 9 is a side view of FIG. 7.

As shown from FIG. 7 to FIG. 9, take the frame device (200) disposed at the outer periphery of the iron core, structured by the iron core with the magnetic loops (300) formed as the square-like member or the rectangular member, of the static electrical machine as an example, the characteristic is that at least one of the top surface, the front surfaces, the left surface, the right surface, the rear surfaces and bottom surface of the frame device (200) is formed with the at least one transversal (X-X) bridge-type heat dissipation fin (101) and the adjacent transversal (X-X) jointly-formed heat dissipation hole (111), so that the heat dissipation performance to the ambient gaseous or liquid environment can be enhanced.

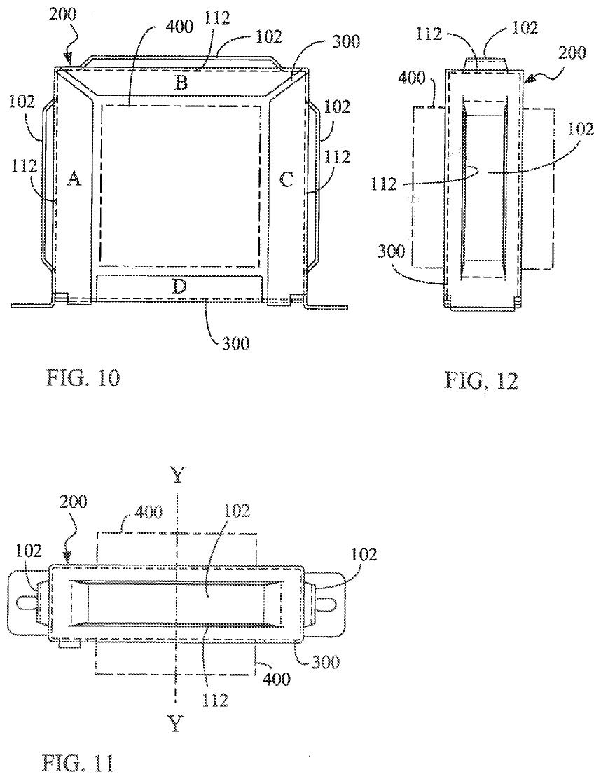

FIG. 10 is a front view showing the frame device (200) being formed with at least one longitudinal (Y-Y) bridge-type heat dissipation fin (102) and an adjacent longitudinal (Y-Y) jointly-formed heat dissipation hole (112) according to the second embodiment of the present invention.

FIG. 11 is a top view of FIG. 10.

FIG. 12 is a side view of FIG. 10.

As shown from FIG. 10 to FIG. 12, take the frame device (200) disposed at the outer periphery of the iron core, structured by the iron core with the magnetic loops (300) formed as the square-like member or the rectangular member, of the static electrical machine as an example, the characteristic is that at least one of the top surface, the front surfaces, the left surface, the right surface, the rear surfaces and bottom surface of the frame device (200) is formed the at least one longitudinal (Y-Y) bridge-type heat dissipation fin (102) and the adjacent longitudinal (Y-Y) jointly-formed heat dissipation hole (112), so that the heat dissipation performance to the ambient gaseous or liquid environment can be enhanced.

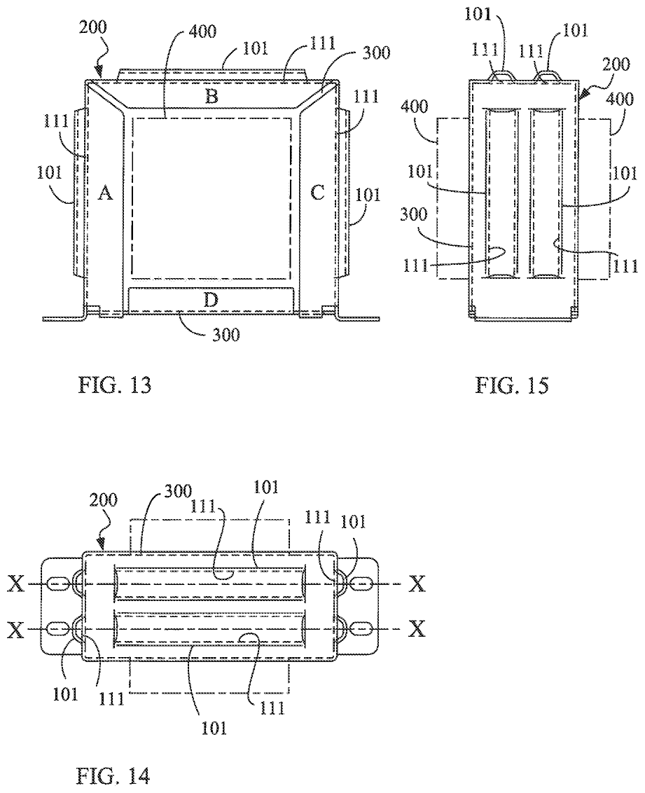

FIG. 13 is a front view showing the frame device (200) being formed with a plurality of the transversal (X-X) bridge-type heat dissipation Bras (101) and the adjacent transversal (X-X) jointly-formed heat dissipation holes (111) according to a third embodiment of the present invention.

FIG. 14 is a top view of FIG. 13.

FIG. 15 is a side view of FIG. 13.

As shown from FIG. 13 to FIG. 15, take the frame device (200) disposed at the outer periphery of the iron core, structured by the iron core with the magnetic loops (300) formed as the square-like member or the rectangular member, of the static electrical machine as an example, the characteristic is that at least one of the top surface, the front surfaces, the left surface, the right surface, the rear surfaces and bottom surface of the frame device (200) is formed with a plurality of the transversal (X-X) bridge-type heat dissipation fins (101) and the adjacent transversal (X-X) jointly-formed heat dissipation holes (111), so that the heat dissipation performance to the ambient gaseous or liquid environment can be enhanced.

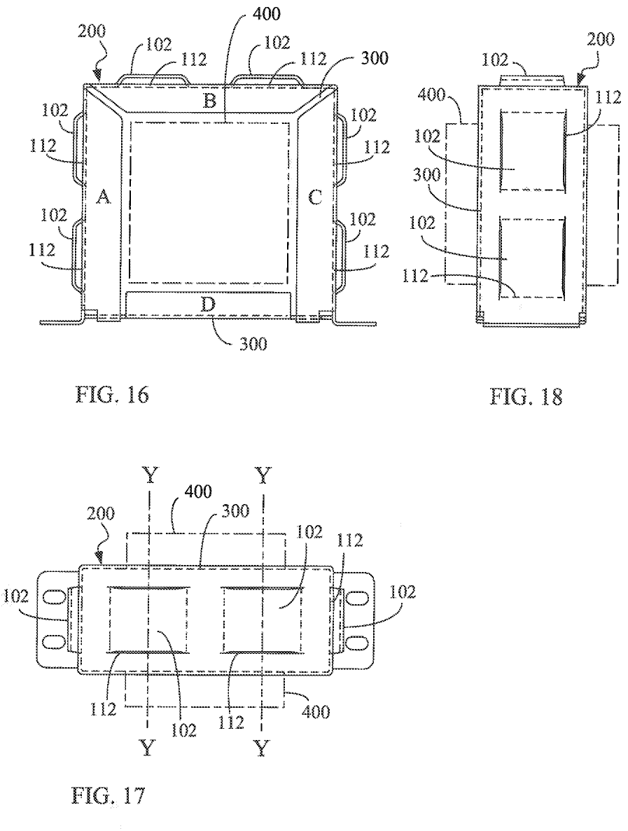

FIG. 16 is a front view showing the frame device (200) being formed with a plurality of the longitudinal (Y-Y) bridge-type heat dissipation fins (102) and the adjacent longitudinal (Y-Y) jointly-formed heat dissipation holes (112) according to a fourth embodiment of the present invention.

FIG. 17 is a top view of FIG. 16.

FIG. 18 is a side view of FIG. 16.

As shown from FIG. 16 to FIG. 18, take the frame device (200) disposed at the outer periphery of the iron core, structured by the iron core with the magnetic loops (300) formed as the square-like member or the rectangular member, of the static electrical machine as an example, the characteristic is that at least one of the top surface, the front surfaces, the left surface, the right surface, the rear surfaces and bottom surface of the frame device (200) is formed with a plurality of the longitudinal (Y-Y) bridge-type heat dissipation fins (102) and the adjacent longitudinal (Y-Y) jointly-formed heat dissipation holes (112), so that the heat dissipation performance to the ambient gaseous or liquid environment can be enhanced,

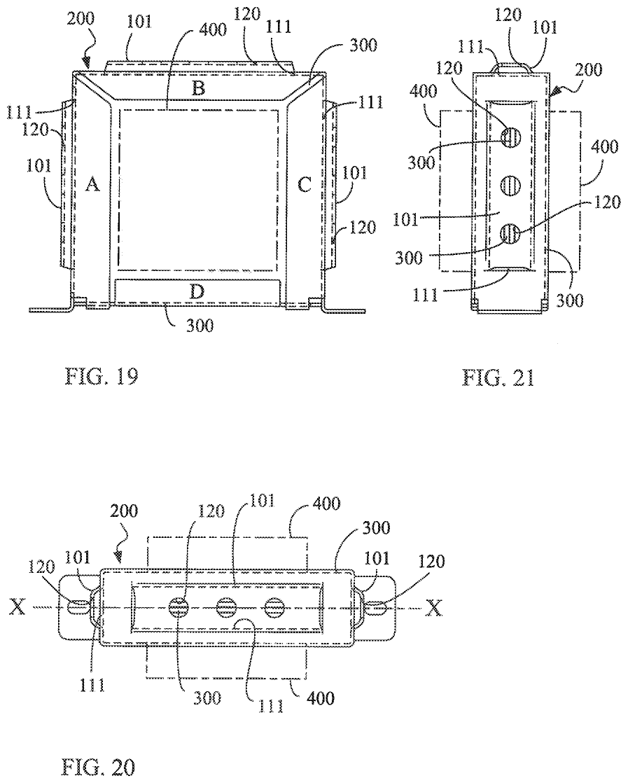

FIG. 19 is a front view showing the frame device (200) being formed with the transversal (X-X) bridge-type heat dissipation fins (101) and the adjacent transversal (X-X) jointly-formed heat dissipation holes (111), and the transversal (X-X) bridge-type heat dissipation fins (101) being respectively formed with at least one flow discharging hole (120) according to a fifth embodiment of the present invention.

FIG. 20 is a top view of FIG. 19,

FIG. 21 is a side view of FIG. 19.

As shown from FIG. 19 to FIG. 21, take the frame device (200) disposed at the outer periphery of the iron core, structured by the iron core with the magnetic loops (300) formed as the square-like member or the rectangular member, of the static electrical machine as an example, the characteristic is that at least one of the top surface, the front surfaces, the left surface, the right surface, the rear surfaces and bottom surface of the frame device (200) is formed with the transversal (X-X) bridge-type heat dissipation fins (101) and the adjacent transversal (X-X) jointly-formed heat dissipation holes (111), and the transversal (X-X) bridge-type heat dissipation fins (101) are respectively formed with the at least one flow discharging hole (120), so that the heat dissipation performance to the ambient gaseous or liquid environment can be enhanced.

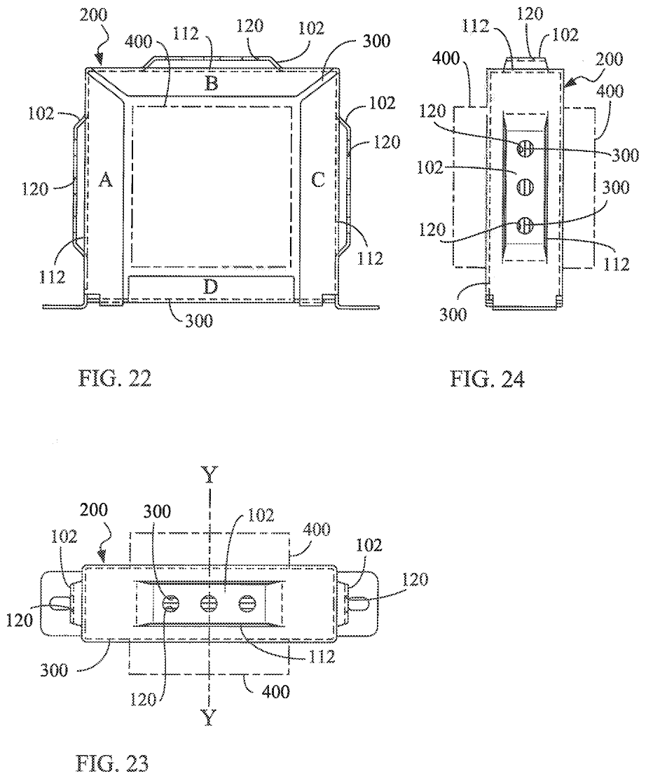

FIG. 22 is a front view showing the frame device (200) being formed with the longitudinal (Y-Y) bridge-type heat dissipation fins (102) and the adjacent longitudinal (Y-Y) jointly-formed heat dissipation holes (112), and the longitudinal (Y-Y) bridge-type heat dissipation fins (102) being respectively formed with the at least one flow discharging hole (120) according to a sixth embodiment of the present invention.

FIG. 23 is a top view of FIG. 22.

FIG. 24 is a side view of FIG. 22.

As shown from FIG. 22 to FIG. 24, take the frame device (200) disposed at the outer periphery of the iron core, structured by the iron core with the magnetic loops (300) formed as the square-like member or the rectangular member, of the static electrical machine as an example, the characteristic is that at least one of the top surface, the front surfaces, the left surface, the right surface, the rear surfaces and bottom surface of the frame device (200) is formed with the longitudinal (Y-Y) bridge-type heat dissipation fins (102) and the adjacent longitudinal (Y-Y) jointly-formed heat dissipation holes (112), and the longitudinal (Y-Y) bridge-type heat dissipation fins (102) are respectively formed with the at least one flow discharging hole (120), so that the heat dissipation performance to the ambient gaseous or liquid environment can be enhanced.

According to the present invention, the above mentioned bridge-type heat dissipation fin can be further consisted of an inclined or a V-shaped bridge-type heat dissipation fin structure and a jointly-formed beat dissipation hole. Detailed illustrations are provided as followings:

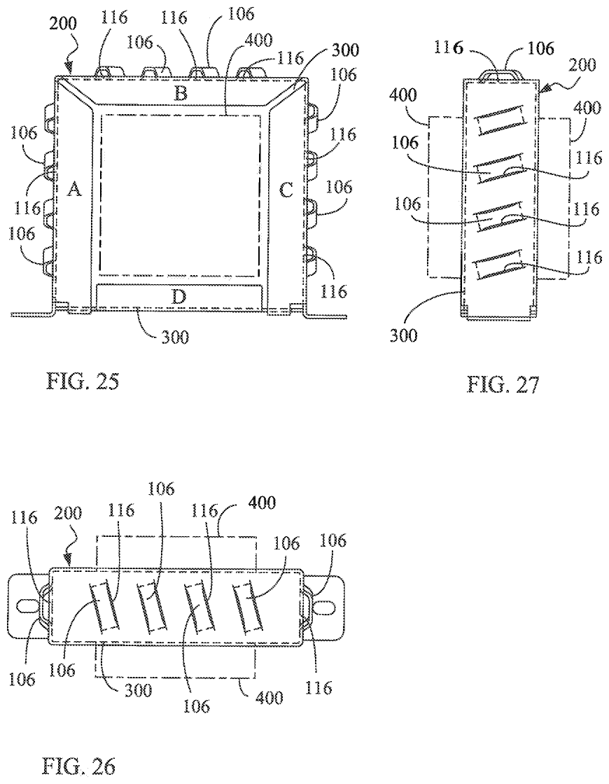

FIG. 25 is a front view showing the frame device (200) being formed with at least one inclined bridge-type heat dissipation fin (106) and an adjacent inclined jointly-formed heat dissipation hole (116) according to a seventh embodiment of the present invention.

FIG. 26 is a top view of FIG. 25.

FIG. 27 is a side view of FIG. 25.

As shown from FIG. 25 to FIG. 27, take the frame device (200) disposed at the outer periphery of the iron core, structured by the iron core with the magnetic loops (300) formed as the square-like member or the rectangular member, of the static electrical machine as an example, the characteristic is that at least one of the top surface, the front surfaces, the left surface, the right surface, the rear surfaces and bottom surface of the frame device (200) is formed with the at least one inclined bridge-type heat dissipation fin (106) and the adjacent inclined jointly-formed heat dissipation hole (116), so that the heat dissipation performance to the ambient gaseous or liquid environment can be enhanced.

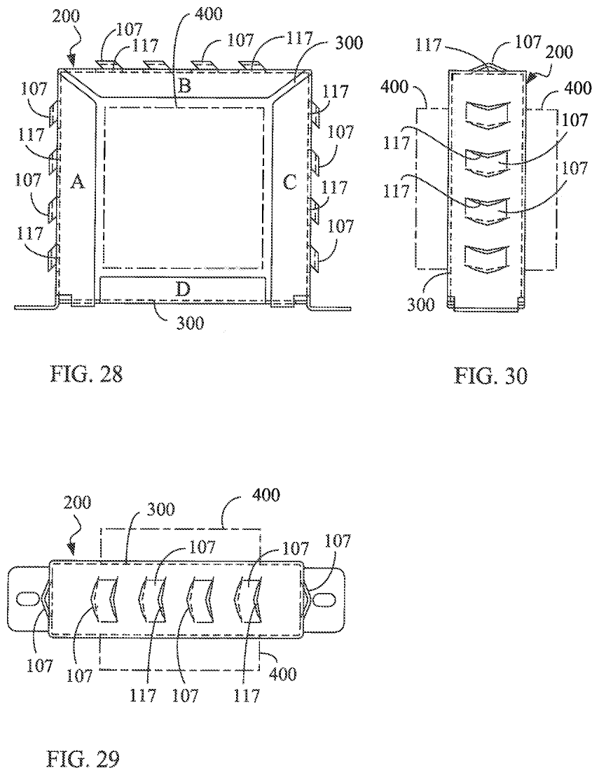

FIG. 28 is a front view showing the frame device (200) being formed with at least one V-shaped bridge-type heat dissipation fin (107) arid an adjacent V-shaped jointly-formed heat dissipation hole (117) according to an eighth embodiment of the present invention.

FIG. 29 is a top view of FIG. 28.

FIG. 30 is a side view of FIG. 28.

As shown from FIG. 28 to FIG. 30, take the frame device (200) disposed at the outer periphery of the iron core, structured by the iron core with the magnetic loops (300) formed as the square-like member or the rectangular member, of the static electrical machine as an example, the characteristic is that at least one of the top surface, the front surfaces, the left surface, the right surface, the rear surfaces and bottom surface is formed of the frame device (200) with the at least one V-shaped bridge-type heat dissipation fin (107) and the adjacent V-shaped jointly-formed heat dissipation hole (117), so that the heat dissipation performance to the ambient gaseous or liquid environment can be enhanced.

According to the present invention, the frame device of iron core of static electrical machine having outwardly-extended heat dissipation fin and/or heat dissipation hole can be further formed with at least one semi-bridge-type heat dissipation fin and at least one jointly-formed heat dissipation hole. Detailed illustrations are provided as followings:

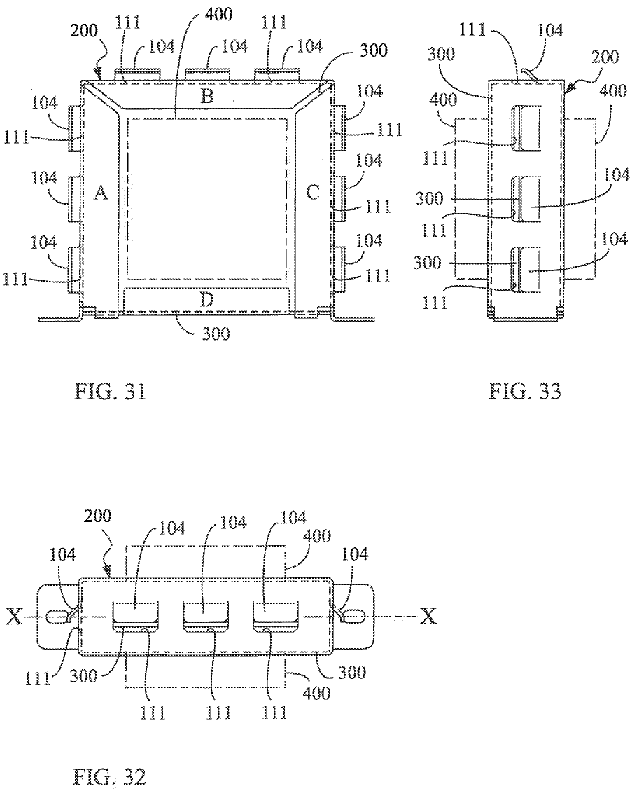

FIG. 31 is a front view showing the frame device (200) being formed with a plurality of transversal (X-X) semi-bridge-type heat dissipation fins (104) and the adjacent transversal (X-X) jointly-formed heat dissipation holes (111) according to a ninth embodiment of the present invention.

FIG. 32 is a top view of FIG. 31.

FIG. 33 is a side view of FIG. 31.

As shown from FIG. 31 to FIG. 33, take the frame device (200) disposed at the outer periphery of the iron core, structured by the iron core with the magnetic loops (300) formed as the square-like member or the rectangular member, of the static electrical machine as an example, the characteristic is that at least one of the top surface, the front surfaces, the left surface, the right surface, the rear surfaces and bottom surface of the frame device (200) is formed with a plurality of the transversal (X-X) semi-bridge-type heat dissipation fins (104) and the adjacent transversal (X-X) jointly-formed heat dissipation holes (111), so that the heat dissipation performance to the ambient gaseous or liquid environment can be enhanced.

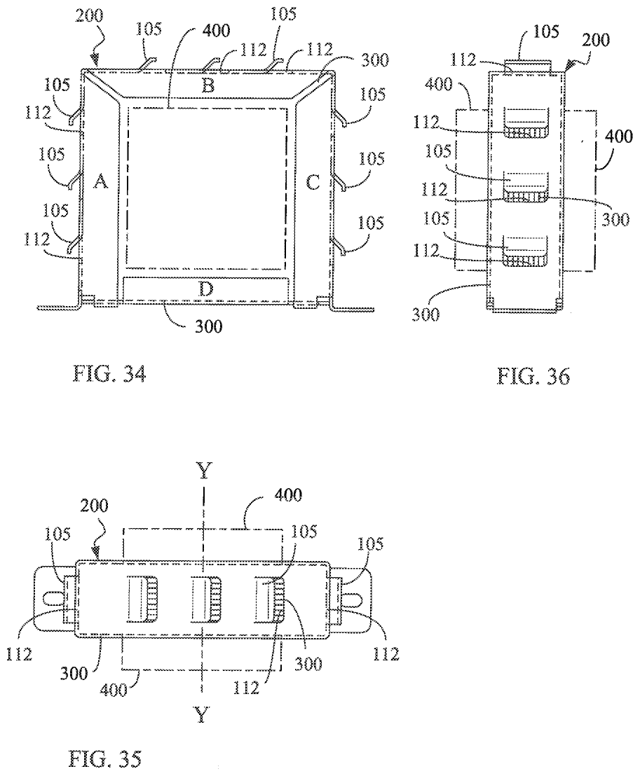

FIG. 34 is a front view showing the frame device (200) being formed with a plurality of longitudinal (Y-Y) semi-bridge-type heat dissipation fins (105) and the adjacent longitudinal (Y-Y) jointly-formed heat dissipation holes (112) according to a tenth embodiment of the present invention.

FIG. 35 is a top view of FIG. 34.

FIG. 36 is a side view of FIG. 34.

As shown from. FIG. 34 to FIG. 36, take the frame device (200) disposed at the outer periphery of the iron core, structured by the iron core with the magnetic loops (300) formed as the square-like member or the rectangular member, of the static electrical machine as an example, the characteristic is that at least one of the top surface, the front surfaces, the left surface, the right surface, the rear surfaces and bottom surface of the frame device (200) is formed with a plurality of the longitudinal (Y-Y) semi-bridge-type heat dissipation fins (105) and the adjacent longitudinal (Y-Y) jointly-formed heat dissipation holes (112), so that the heat dissipation performance to the ambient gaseous or liquid environment can be enhanced.

As shown in FIG. 31 to FIG. 36, the arranging means of the semi-bridge-type heat dissipation fins disclosed in the frame device of iron core of static electrical machine having outwardly-extended heat dissipation fin and/or heat dissipation hole provided by the present invention include being arranged at the same side or being staggeringly arranged at different sides. Detailed illustrations are provided as followings:

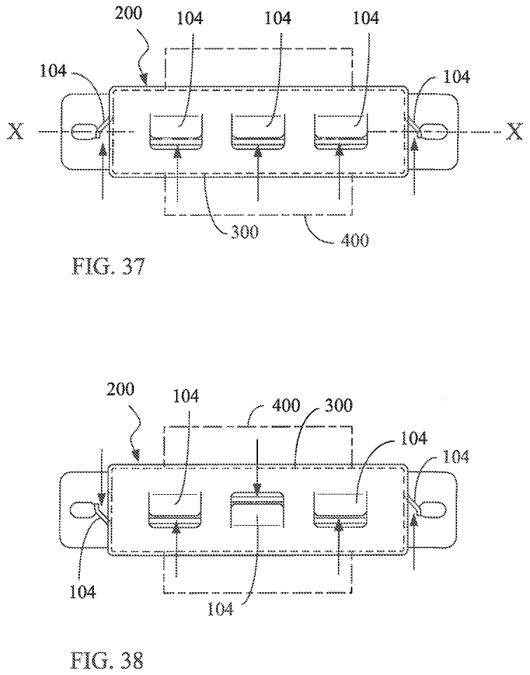

FIG. 37 is a front view showing the frame device (200) being formed with the transversal (X-X) semi-bridge-type heat dissipation fins (104) arranged at the same side and the adjacent transversal (X-X) jointly-farmed heat dissipation holes (111) according to one embodiment of the present invention.

As shown in FIG. 37, take the frame device (200) disposed at the outer periphery of the iron core, structured by the iron core with the magnetic loops (300) formed as the square-like member or the rectangular member, of the static electrical machine as an example, the characteristic is that at least one of the top surface, the front surfaces, the left surface, the right surface, the rear surfaces and bottom surface of the frame device (200) is formed with the plural transversal (X-X) semi-bridge-type heat dissipation fins (104) and the adjacent transversal (X-X) jointly-formed heat dissipation holes (111), and the adjacent transversal (X-X) semi bridge-type heat dissipation fins (104) are arranged at the same side, so that the heat dissipation performance to the ambient gaseous or liquid environment can he enhanced.

FIG. 38 is a front view showing the frame device (200) being formed with the transversal (X-X) semi-bridge-type heat dissipation fins (104) staggeringly arranged at different sides and the adjacent transversal (X-X) jointly-formed heat dissipation holes (111) according to one embodiment of the present invention,

As shown in FIG. 38, take the frame device (200) disposed at the outer periphery of the iron core, structured by the iron core with the magnetic loops (300) formed as the square-like member or the rectangular member, of the static electrical machine as an example, the characteristic is that at least one of the top surface, the front surfaces, the left surface, the right surface, the rear surfaces and bottom surface of the :frame device (200) is formed with the plural transversal (X-X) semi-bridge-type heat dissipation fins (104) and the adjacent transversal (X-X) jointly-formed heat dissipation holes (111), and the adjacent transversal (X-X) semi-bridge-type heat dissipation fins (104) are staggeringly arranged at different sides, so that the heat dissipation performance to the ambient gaseous or liquid environment can be enhanced.

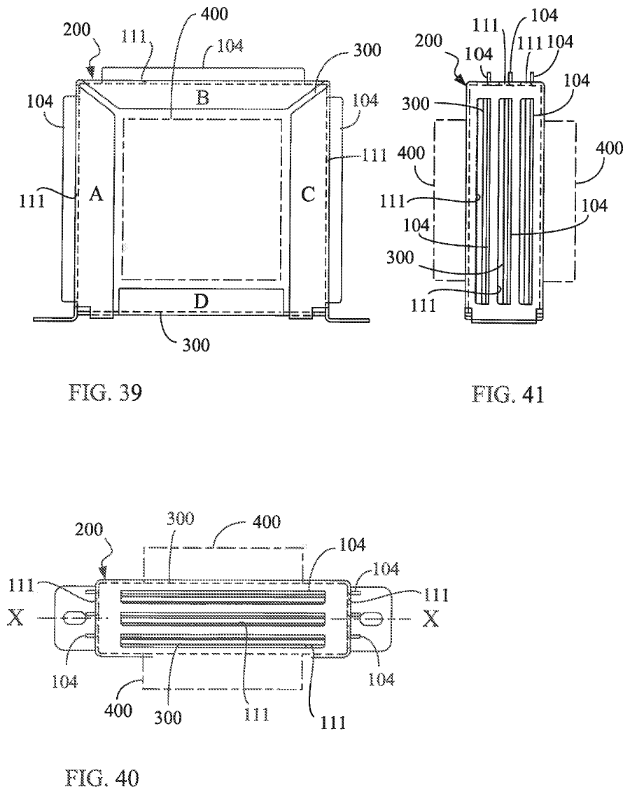

FIG. 39 is a front view showing the frame device (200) being formed with the at least one transversal (X-X) semi-bridge-type heat dissipation fin (104) arranged at the same side and as multiple rows and the adjacent transversal (X-X) jointly-formed heat dissipation holes (111) according to an eleventh embodiment of the present invention.

FIG. 40 is a top view of FIG. 39.

FIG. 41 is a side view of FIG. 39.

As shown from FIG. 39 to FIG. 41, take the frame device (200) disposed at the outer periphery of the iron core, structured by the iron core with the magnetic loops (300) formed as the square-like member or the rectangular member, of the static electrical machine as an example, the characteristic is that at least one of the top surface, the front surfaces, the left surface, the right surface, the rear surfaces and bottom surface of the frame device (200) is formed with the at least one transversal (X-X) semi-bridge-type heat dissipation fin (104) arranged at the same side and as multiple rows and the adjacent transversal (X-X) jointly-formed heat dissipation hole (111), so that the heat dissipation performance to the ambient gaseous or liquid environment can be enhanced.

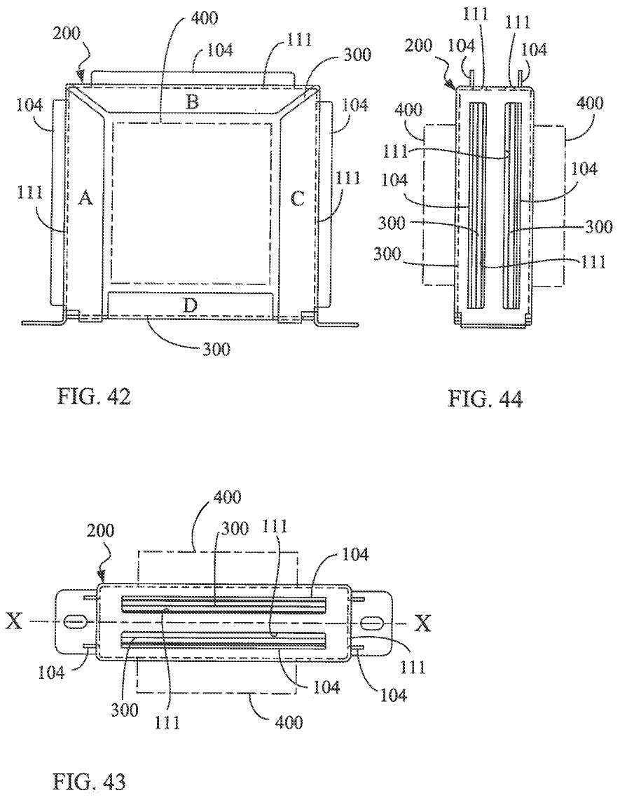

FIG. 42 is a front view showing the frame device (200) being formed the at least one transversal (X-X) sewn-bridge-type heat dissipation fin (104) arranged at different sides and as multiple rows and the adjacent transversal (X-X) jointly-formed heat dissipation hole (111) according to a twelfth embodiment of the present invention.

FIG. 43 is a top view of FIG. 42.

FIG. 44 is a side view of FIG. 42.

As shown from FIG. 42 to FIG. 44, take the frame device (200) disposed at the outer periphery of the iron core, structured by the iron core with the magnetic loops (300) formed as the square-like member or the rectangular member, of the static electrical machine as an example, the characteristic is that at least one of the top surface, the front surfaces, the left surface, the right surface, the rear surfaces and bottom surface of the frame device (200) is formed with the at least one transversal (X..X) semi-bridge-type heat dissipation fin (104) arranged at different sides and as multiple rows and the adjacent transversal (X-X) jointly-formed heat dissipation hole (111), so that the heat dissipation performance to the ambient gaseous or liquid environment can be enhanced.

According to the present invention, the frame device of iron core of static electrical machine having outwardly-extended heat dissipation fin and/or heat dissipation hole can be provided with another characteristic which is that an outer edge of at least one of the adjacent surfaces between the frame device (200) and the iron core of the static electrical machine can be formed with an outwardly-bent-from-outer-edge heat dissipation fin (103). Detailed illustrations are provided as followings:

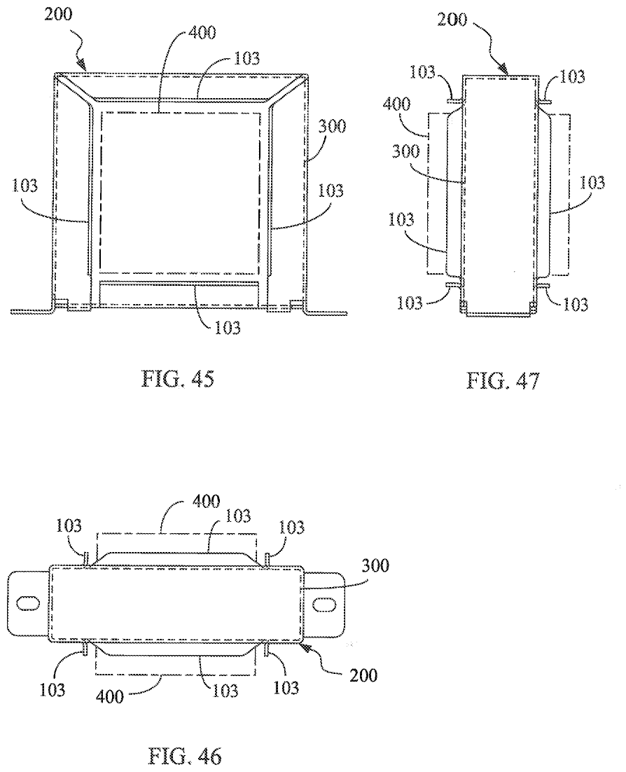

FIG. 45 is a front view showing at least one of the outer edges of the adjacent surfaces between the frame device (200) and the iron core of the static electrical machine being formed with an outwardly-bent-from-outer-edge heat dissipation fin (103) according to a thirteenth embodiment of the present invention.

FIG. 46 is a top view of FIG. 45.

FIG. 47 is a side view of FIG. 45.

As shown from FIG. 45 to FIG. 47, take the frame device (200) disposed at the outer periphery of the iron core, structured by the iron core with the magnetic loops (300) formed as the square-like member or the rectangular member, of the static electrical machine as an example, the characteristic is that at least one of the outer edges of the adjacent surfaces between the frame device (200) and the iron core of the static electrical machine, which are the top surface, the front surfaces, the left surface, the right surface, the rear surfaces and bottom surface, is formed with the outwardly-bent-from-outer-edge heat dissipation fin (103), so that the heat dissipation performance to the ambient gaseous or liquid environment can be enhanced.

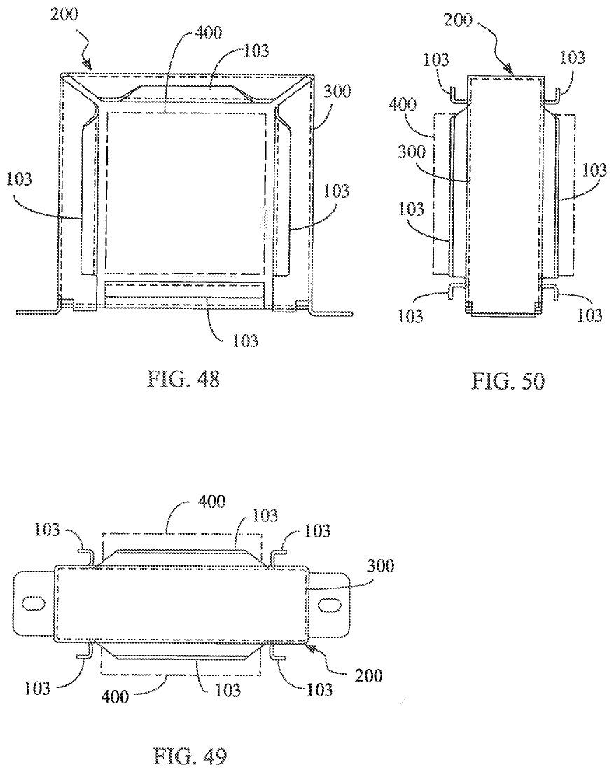

FIG. 48 is a front view showing at least one of the outer edges of the adjacent surfaces between the frame device (200) and the iron core of the static electrical machine being formed with the outwardly-bent-from-outer-edge heat dissipation fin (103) in a multi-bending structural status according to a fourteenth embodiment of the present invention.

FIG. 49 is a top view of FIG. 48.

FIG. 50 is a side view of FIG. 48.

As shown from FIG. 48 to FIG. 50, take the frame device (200) disposed at the outer periphery of the iron core, structured by the iron core with the magnetic loops (300) formed as the square-like member or the rectangular member, of the static electrical machine as an example, the characteristic is that at least one of the outer edges of the adjacent surfaces between the frame device (200) and the iron core of the static electrical machine, which are the top surface, the front surfaces, the left surface, the right surface, the rear surfaces and bottom surface, is formed with the outwardly-bent-from-outer-edge heat dissipation fin (103) in the multi-bending structural status for further increasing the heat dissipation area, so that the heat dissipation performance to the ambient gaseous or liquid environment can be enhanced.

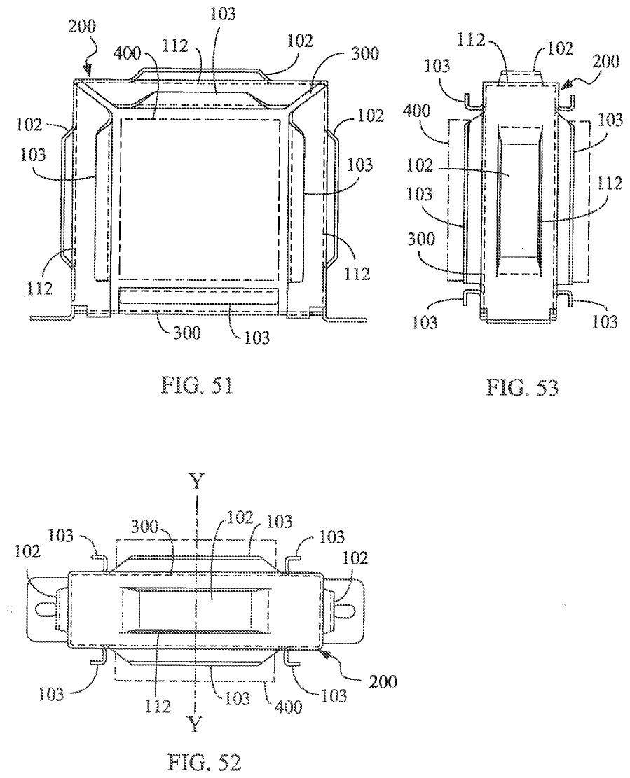

FIG. 51 is a front view showing the frame device (200) being formed with the longitudinal (Y-Y) bridge-type heat dissipation fins (102) and the adjacent longitudinal (Y-Y) jointly-formed heat dissipation holes (112), and at least one of the outer edges of the adjacent surfaces between the frame device (200) and the iron core of the static electrical machine being formed with the outwardly-bent-from-outer-edge heat dissipation fin (103) in a multi-bending structural status according to a fifteenth embodiment of the present invention.

FIG. 52 is a top view of FIG. 51.

FIG. 53 is a side view of FIG. 51.

As shown from FIG. 51 to FIG. 53, take the frame device (200) disposed at the outer periphery of the iron core, structured by the iron core with the magnetic loops (300) formed as the square-like member or the rectangular member, of the static electrical machine as an example, the characteristic is that at least one of the top surface, the front surfaces, the left surface, the right surface, the rear surfaces and bottom surface of the frame device (200) is formed with the longitudinal (Y-Y) bridge-type heat dissipation fins (102) and the adjacent longitudinal (Y-Y) jointly-formed heat dissipation holes (112), and at least one of the outer edges of the adjacent surfaces between the frame device (200) and the iron core of the static electrical machine, which are top surface, the front surfaces, the left surface, the right surface, the rear surfaces and bottom surface, is formed with the outwardly-bent-from-outer-edge heat dissipation fin (103) in the multi-bending structural status for further increasing the heat dissipation area, so that the heat dissipation performance to the ambient gaseous or liquid environment can be enhanced.

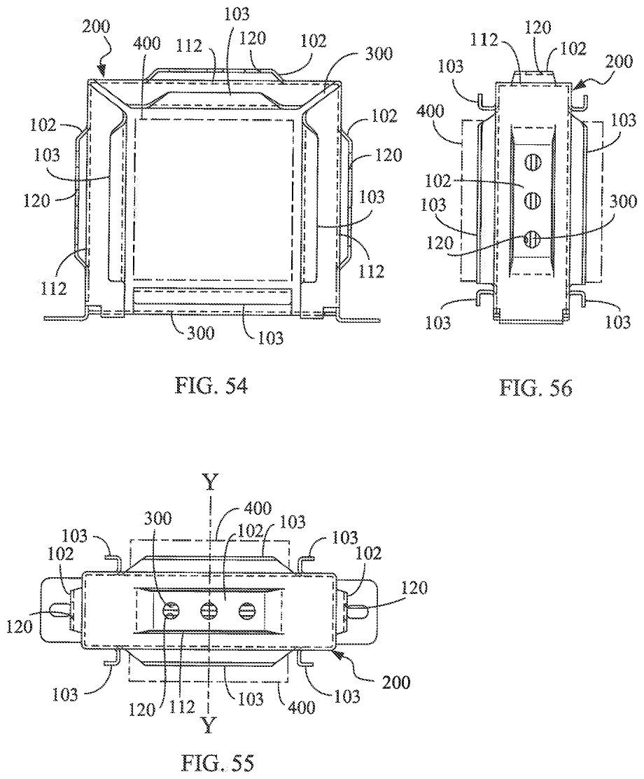

FIG. 54 is a front view showing the frame device (200) being formed with the longitudinal (Y-Y) bridge-type heat dissipation fins (102) and the adjacent longitudinal (Y-Y) jointly-formed heat dissipation holes (112), the longitudinal (Y-Y) bridge-type heat dissipation fins (102) being respectively formed with the at least one flow discharging hole (120), and at least one of the outer edges of the adjacent surfaces between the frame device (200) and the iron core of the static electrical machine being formed with the outwardly-bent-from-outer-edge heat dissipation fin (103) in a multi-bending structural status according to a sixteenth embodiment of the present invention.

FIG. 55 is a top view of FIG. 54.

FIG. 56 is a side view of FIG. 54.

As shown from FIG. 54 to FIG. 56, take the frame device (200) disposed at the outer periphery of the iron core, structured by the iron core with the magnetic loops (300) formed as the square-like member or the rectangular member, of the static electrical machine as an example, the characteristic is that at least one of the top surface, the front surfaces, the left surface, the right surface, the rear surfaces and bottom surface of the frame device (200) is formed with the longitudinal (Y-Y) bridge-type heat dissipation fins (102) and the adjacent longitudinal (Y-Y) jointly-formed heat dissipation holes (112), the longitudinal (Y-Y) bridge-type heat dissipation fins (102) are respectively formed with the at least one flow discharging hole (120), and at least one of the outer edges of the adjacent surfaces between the fame device (200) and the iron core of the static electrical machine, which are top surface, the front surfaces, the left surface, the right surface, the rear surfaces and bottom surface, is formed with the outwardly-bent-from-outer-edge heat dissipation fin (103) in the multi-bending structural status for further increasing the heat dissipation area, so that the heat dissipation performance to the ambient gaseous or liquid environment can be enhanced.

According to the frame device of iron core of static electrical machine having outwardly-extended heat dissipation fin and/or heat dissipation hole provided by the present invention, besides the transversal (X-X) bridge-type heat dissipation fin (101) or transversal (X-X) semi-bridge-type heat dissipation fin (104) and the adjacent transversal (X-X) jointly-formed heat dissipation hole (111), the longitudinal (Y-Y) bridge-type heat dissipation fin (102) or the longitudinal (Y-Y) semi-bridge-type heat dissipation fin (105) and the adjacent longitudinal (Y-Y) jointly-formed heat dissipation hole (112), the inclined bridge-type heat dissipation fin (106) and the adjacent inclined jointly-formed heat dissipation hole (116), and the V-shaped bridge-type heat dissipation fin (107) and the adjacent V-shaped jointly-formed heat dissipation hole (117) can be configured to provide a function of directly dissipating heat to the exterior to the iron core with the magnetic loops (300), the present invention is further provided with a characteristic which is that at least one of the adjacent surfaces between the frame device (200) of the iron core of the static electrical machine and the iron core with the magnetic loops (300) can be formed with a heat dissipation hole (130) formed as a square-like member or a the rectangular member and allowing the iron core with the magnetic loops (300) to directly dissipate heat to the exterior. Detailed illustrations are provided as followings:

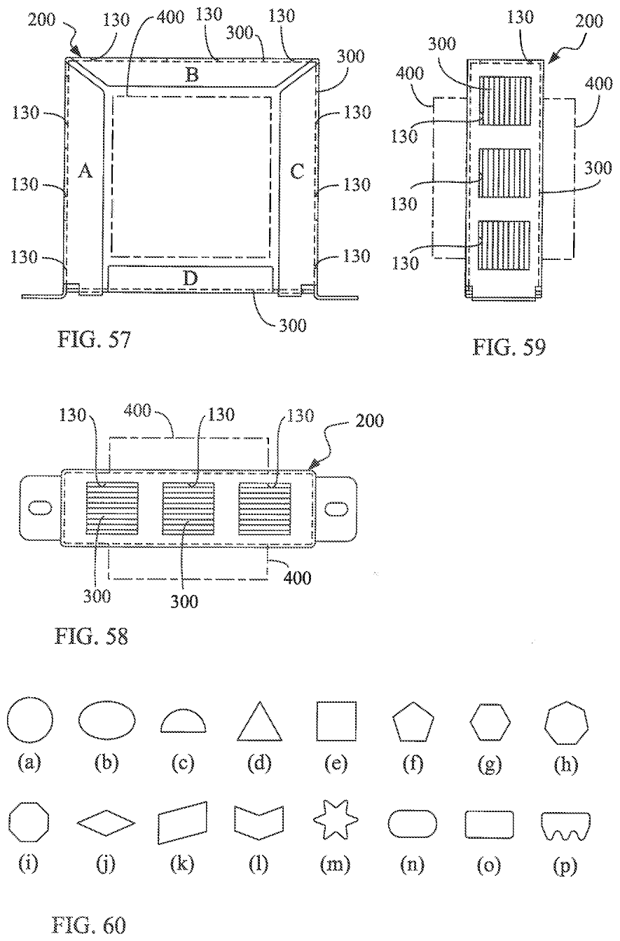

FIG. 57 is a front view showing at least one of the adjacent surfaces between the frame device (200) of the iron core of the static electrical machine and the iron core with the magnetic loops (300) being formed with a rectangular heat dissipation hole (130) allowing the iron core with the magnetic loops (300) to directly dissipate heat to the exterior according to one embodiment of the present invention.

FIG. 58 is a top view of FIG. 57,

FIG. 59 is a side view of FIG. 57.

As shown from FIG. 57 to FIG. 59, take the frame device (200) disposed at the outer periphery of the iron core, structured by the iron core with the magnetic loops (300) formed as the square-like member or the rectangular member, of the static electrical machine as an example, the characteristic is that at least one of the adjacent surfaces between the frame device (200) of the iron core of the static electrical machine, which are the top surface, the front surface, the left surface, the right surface, the rear surface and bottom surface, and the iron core with the magnetic loops (300) is formed with the rectangular heat dissipation hole (130) allowing the iron core with the magnetic loops (300) to directly dissipate heat to the exterior, so that the heat dissipation performance to the ambient gaseous or liquid environment can be enhanced.

FIG. 60 is a schematic view showing various shapes applicable to the jointly-formed adjacent transversal (X-X) heat dissipation holes (111), the jointly-formed adjacent longitudinal (Y-Y) heat dissipation holes (112), the jointly-formed adjacent inclined heat dissipation hole (116), the adjacent V-shaped jointly-formed heat dissipation hole (117) and the heat dissipation hole (130) formed on the adjacent surfaces between the frame device (200) of the iron core of the static electrical machine and the iron core with the magnetic loops (300) and allowing the iron core with the magnetic loops (300) to directly dissipate heat to the exterior according to one embodiment of the present invention.

As shown in FIG. 60, take the frame device (200) disposed at the outer periphery of the iron core, structured by the iron core with the magnetic loops (300) formed as the square-like member or the rectangular member, of the static electrical machine as an example, the characteristic is that at least one of the adjacent surfaces between the frame device (200) of the iron core of the static electrical machine and the iron core with the magnetic loops (300) is formed with a dissipation hole having various arc-like shapes and/or a polygonal beat dissipation hole, for example the transversal (X-X) jointly-formed heat dissipation hole (111), the longitudinal (Y-Y) jointly-formed heat dissipation hole (112), the inclined jointly-formed heat dissipation hole (116), the V-shaped jointly-formed heat dissipation hole (117) and the heat dissipation hole (130) includes a hole-like shape or a slot-like shape such as; (a) a round dissipation hole; (b) an oval dissipation hole; (c) semi-round dissipation hole; (d) triangular dissipation hole; (e) rectangular dissipation hole; (0 a pentagonal dissipation hole; (g) a hexagonal dissipation hole; (h) a heptagonal dissipation hole; (i) an octagonal dissipation hole; (j) a rhombus dissipation hole; (k) an inclined dissipation hole; (l) a V-shaped dissipation hole; (m) a star-like dissipation hole; (n) a rectangular oval-slot-like dissipation hole with two sides being in an convex arc-shaped status; (o) a rectangular slot-like dissipation hole; (p) a dissipation hole having at least one side formed in a teeth-like status; or other dissipation holes formed with different geometrical shapes, and the dissipation hole disclosed in the present invention is formed through at least one of the above-mentioned shapes and statuses; what shall be addressed is that the above-mentioned (a) to (p) are merely served for illustrations, and other geometrical shapes shall be within the scope of the present invention.

According to the present invention, the characteristic of the frame device of iron core of static electrical machine having outwardly-extended heat dissipation fin and/or heat dissipation hole is that the frame device (200) formed with the outwardly-extended heat dissipation fin and/or the heat dissipation hole (300) allowing heat to the directly dissipate to the exterior is able to configure an optimized structure for enhancing the heat transferring performance of the iron core with the magnetic loops (300) to the ambient gaseous or liquid environment, wherein:

the outwardly-extended heat dissipation fin and the heat dissipation hole include one or more than one of the followings:
(1) transversal (X-X) bridge-type heat dissipation fin (101);
(2) longitudinal (Y-Y) bridge-type heat dissipation fin (102);
(3) outwardly-bent-from-outer-edge heat dissipation fin (103);
(4) transversal (X-X) semi-bridge-type heat dissipation fin (104);
(5) longitudinal (Y-Y) semi-bridge-type heat dissipation fin (105);
(6) inclined bridge-type heat dissipation fin (106);
(7) V-shaped bridge-type heat dissipation fin (107);
(8) transversal (X-X) jointly-formed heat dissipation hole (111);
(9) longitudinal (Y-Y) jointly-formed heat dissipation hole (112);
(10) inclined jointly-formed heat dissipation hole (116);
(11) V-shaped jointly-formed heat dissipation hole (117); and
(12) heat dissipation hole (130) formed on the adjacent surfaces between the frame device (200) and the iron core with the magnetic loops (300) and allowing the iron core with the magnetic loops (300) to directly dissipate heat to the exterior.

According to the frame device of iron core of static electrical machine having outwardly-extended heat dissipation fin and/or heat dissipation hole provided by the present invention, one or more than one of the above-mentioned heat dissipation structure can be disposed on at least one of the six surfaces, which are the top surface, the front surfaces, the left surface, the right surface, the rear surfaces and the bottom surface, of the frame device (200) arranged at the outer periphery of the iron core with the magnetic loops (300) of the static electrical machine with respect to the actual needs and the actual required quantity. Detailed illustrations are provided as followings, but What shall be addressed is that the followings are merely served for illustrations and shall not be deemed as a limitation to the structural configuration and the quantity of the outwardly-extended heat dissipation fin and/or the shape and the quantity of the heat dissipation hole.

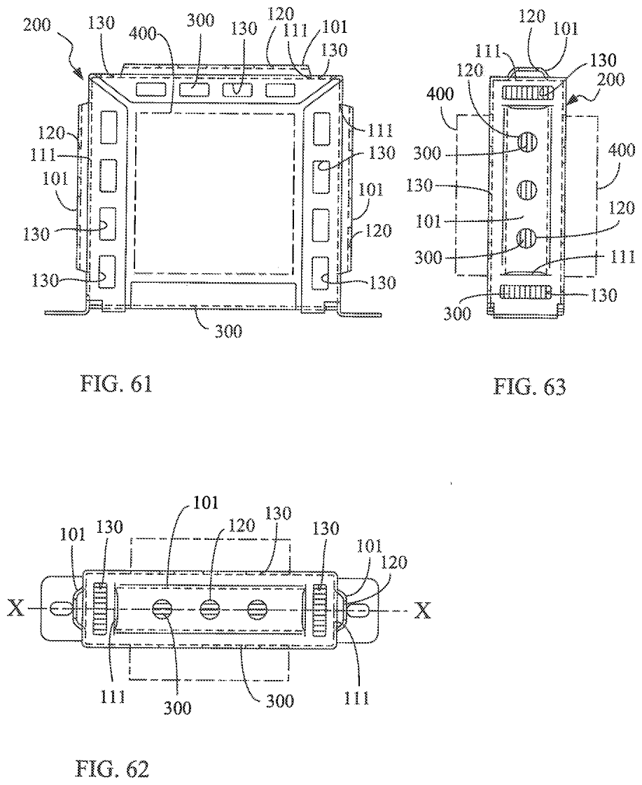

FIG. 61 is a front view showing the frame device (200) being formed with the transversal (X-X) bridge-type heat dissipation fins (101) and the adjacent transversal (X-X) jointly-formed heat dissipation holes (111), the transversal (X-X) bridge-type heat dissipation fins (101) being respectively formed with the at least one flow discharging hole (120), and the adjacent surfaces between the frame device (200) and the iron with the magnetic loops (300) being formed with the heat dissipation hole (130) allowing the iron core with the magnetic loops (300) to directly dissipate heat to the exterior according to a seventeenth embodiment of the present invention.

FIG. 62 is a top view of FIG. 61.

FIG. 63 is a side view of FIG. 61.

As shown from FIG. 61 to FIG. 63, take the frame device (200) disposed at the outer periphery of the iron core, structured by the iron core with the magnetic loops (300) formed as the square-like member or the rectangular member, of the static electrical machine as an example, the characteristic is that the frame device (200) is formed with the transversal (X-X) bridge-type heat dissipation fins (101) and the adjacent transversal (X-X) jointly-formed heat dissipation holes (111), the transversal (X-X) bridge-type heat dissipation fins (101) are respectively formed with the at least one flow discharging hole (120), and the adjacent surfaces between the frame device (200) and the iron with the magnetic loops (300) are formed with the heat dissipation hole (130) allowing the iron core with the magnetic loops (300) to directly dissipate heat to the exterior, so that the heat dissipation performance to the ambient gaseous or liquid environment can be enhanced.

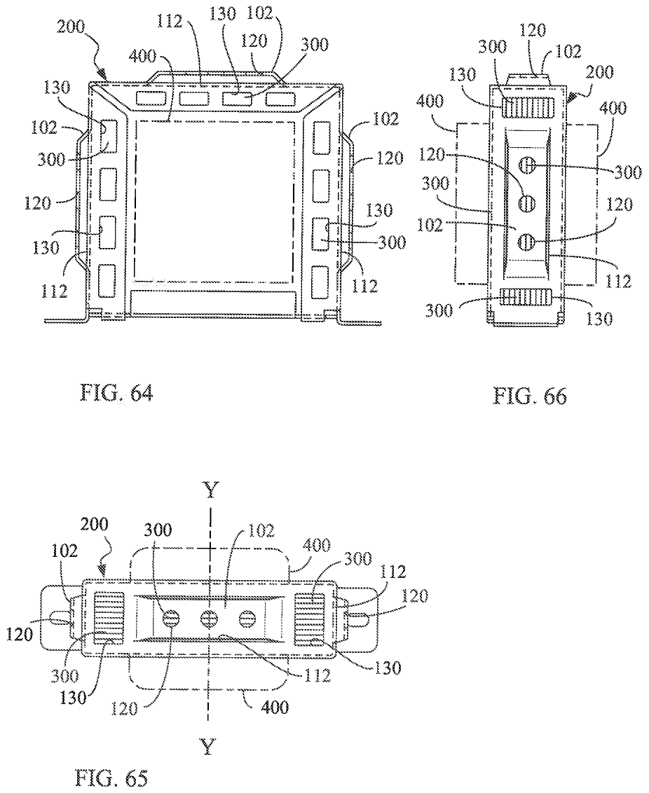

FIG. 64 is a front view showing the frame device (200) being formed with the longitudinal (Y-Y) bridge-type heat dissipation fins (102) and the adjacent longitudinal (Y-Y) jointly-formed heat dissipation holes (112), the longitudinal (Y-Y) bridge-type heat dissipation fins (102) being respectively formed with the at least one flow discharging hole (120), and the adjacent surfaces between the frame device (200) and the iron with the magnetic loops (300) being formed with the heat dissipation hole (130) allowing the iron core with the magnetic loops (300) to directly dissipate heat to the exterior according to an eighteenth embodiment of the present invention.

FIG. 65 is a top view of FIG. 64.

FIG. 66 is a side view of FIG. 64.

As shown from FIG. 64 to FIG. 66, take the frame device (200) disposed at the outer periphery of the iron core, structured by the iron core with the magnetic loops (300) formed as the square-like member or the rectangular member, of the static electrical machine as an example, the characteristic is that the frame device (200) is formed with the longitudinal (Y-Y) bridge-type heat dissipation fins (102) and the adjacent longitudinal (Y-Y) jointly-formed heat dissipation holes (112), the longitudinal (Y-Y) bridge-type heat dissipation fins (102) are respectively formed with the at least one flow discharging hole (120), and the adjacent surfaces between the frame device (200) and the iron with the magnetic loops (300) are formed with the heat dissipation hole (130) allowing the iron core with the magnetic loops (300) to directly dissipate heat to the exterior, so that the heat dissipation performance to the ambient gaseous or liquid environment can be enhanced

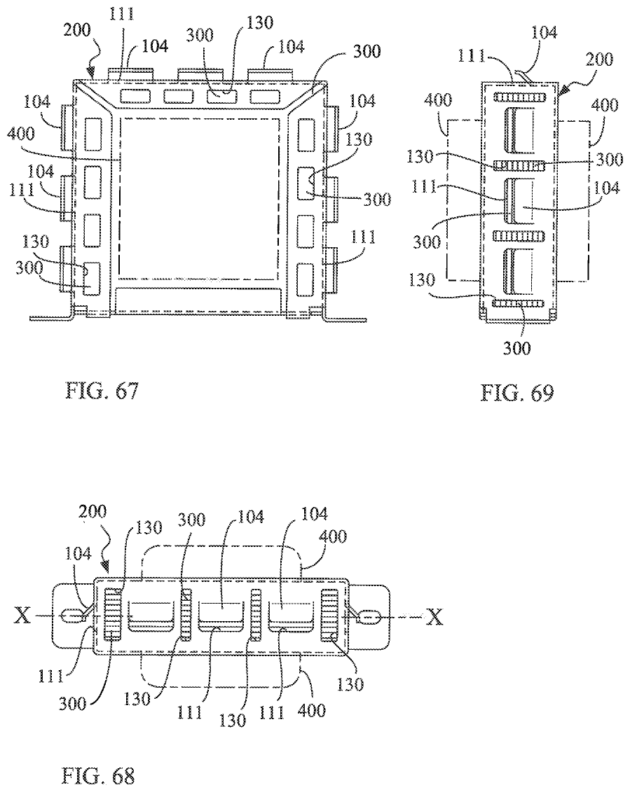

FIG. 67 is a front view showing the frame device (200) being formed with the at least one transversal (X-X) semi-bridge-type heat dissipation fin (104) and the adjacent transversal (X-X) jointly-formed heat dissipation hole (111), and the adjacent surfaces between the frame device (200) and the iron with the magnetic loops (300) being formed with the heat dissipation hole (130) allowing the iron core with the magnetic loops (300) to directly dissipate heat to the exterior according to a nineteenth embodiment of the present invention.

FIG. 68 is a top view of FIG. 67.

FIG. 69 is a side view of FIG. 67.

As shown from. FIG. 67 to FIG. 69, take the frame device (200) disposed at the outer periphery of the iron core, structured by the iron core with the magnetic loops (300) formed as the square-like member or the rectangular member, of the static electrical machine as an example, the characteristic is that the frame device (200) is formed with the at least one transversal (X-X) semi-bridge-type heat dissipation fin (104) and the adjacent transversal (X-X) jointly-formed heat dissipation hole (111), and the adjacent surfaces between the frame device (200) and the iron with the magnetic loops (300) are formed with the heat dissipation hole (130) allowing the iron core with the magnetic loops (300) to directly dissipate heat to the exterior, so that the heat dissipation performance to the ambient gaseous or liquid environment can be enhanced.

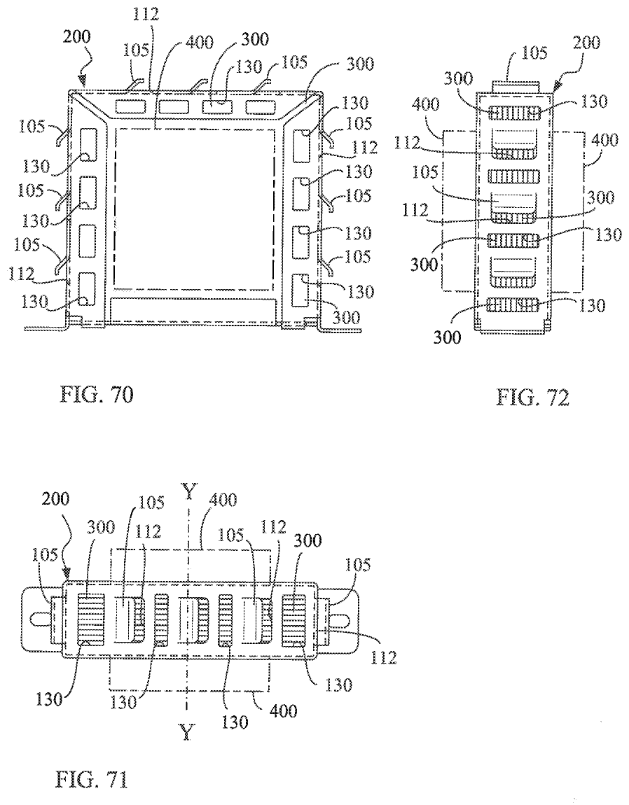

FIG. 70 is a front view showing the frame device (200) being formed with the at least one longitudinal (Y-Y) semi-bridge-type heat dissipation fin (105) and the adjacent longitudinal (Y-Y) jointly-formed heat dissipation hole (112), and the adjacent surfaces between the frame device (200) and the iron with the magnetic loops (300) being formed with the heat dissipation hole (130) in a rectangular slot-like status and allowing the iron core with the magnetic loops (300) to directly dissipate heat to the exterior according to a twentieth embodiment of the present invention.

FIG. 71 is a top view of FIG. 70.

FIG. 72 is a side view of FIG. 70.

As shown from FIG. 70 to FIG. 72, take the frame device (200) disposed at the outer periphery of the iron core, structured by the iron core with the magnetic loops (300) formed as the square-like member or the rectangular member, of the static electrical machine as an example, the characteristic is that the frame device (200) is formed with the at least one longitudinal (Y-Y) semi-bridge-type heat dissipation fin (105) and the adjacent longitudinal (Y-Y) jointly-formed heat dissipation hole (112), and the adjacent surfaces between the frame device (200) and the iron with the magnetic loops (300) are formed with the heat dissipation hole (130) in the rectangular slot-like status and allowing the iron core with the magnetic loops (300) to directly dissipate heat to the exterior, so that the heat dissipation performance to the ambient gaseous or liquid environment can be enhanced.

As shown in aforementioned FIG. 34 to FIG. 36, the embodiment utilizes the longitudinal (Y-Y) semi-bridge-type heat dissipation fin (105) to increase the external heat dissipation and with the adjacent longitudinal (Y-Y) jointly-formed heat dissipation holes (112) for direct heat dissipation by the surface of iron core. However, while the longitudinal (Y-Y) semi-bridge-type heat dissipation fin (105) is not utilized under spatial consideration, and the external frame device is made by good electrical conducting material, under some operating status such as temporary overloading operation the iron core magnetic leakage will induce eddy-current heat loss on the frame device cladding the iron-core. For reducing the eddy-current heat loss, the external frame could further fabricate with eddy-current blocking structure which composed by longitudinal (Y-Y) oriented perforated slots or long grooves, so that the capability of heat dissipation to the ambient gaseous or liquid environment can still be enhanced.

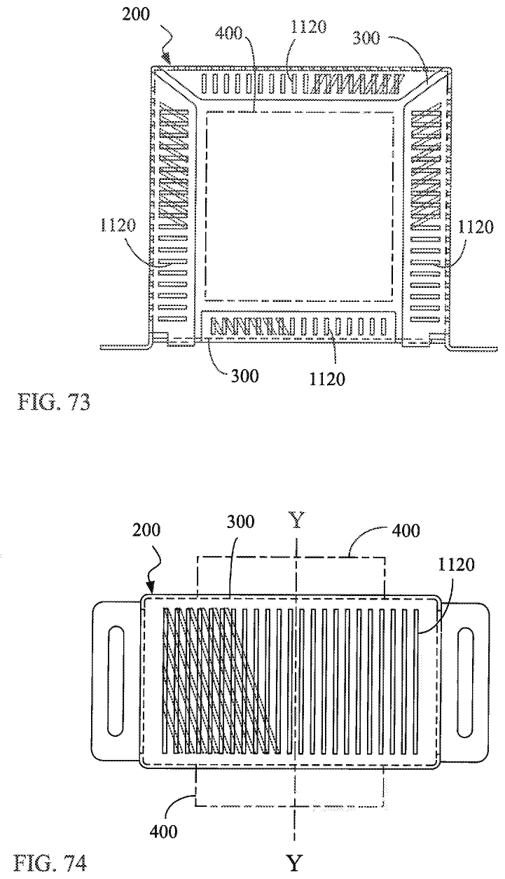

FIG. 73 is a front view showing the frame device (200) wherein at least one surface of the frame device is being formed with multi-row at least one of longitudinal (Y-Y) or near inclined longitudinal (Y-Y) adjacently arranged eddy-current blocking structure (1120) which consist of at least one perforated slots or long grooves fabricate in longitudinal (Y-Y) or inclined longitudinal (Y-Y) orientation according to a twenty first embodiment of the present invention.

FIG. 74 is a top view of FIG. 73.

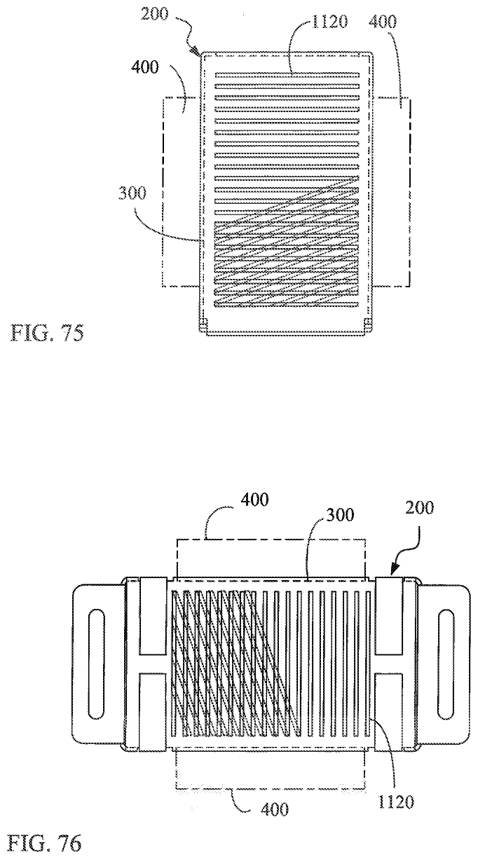

FIG. 75 is a side view of FIG. 73.

FIG. 76 is a bottom view of FIG. 73,

As shown from FIG. 73 to FIG. 76, take the frame device (200) disposed at the outer periphery of the iron core, structured by the iron core with the magnetic loops (300) formed as the square-like member or the rectangular member, of the static electrical machine as an example, the characteristic is that at least one of the top surface, the front surfaces, the left surface, the right surface, the rear surfaces and bottom surface of the frame device (200) is formed with at least one longitudinal (Y-Y) or inclined longitudinal (Y-Y) eddy-current blocking structure (1120) which consist of at least one perforated slots or long grooves, in addition to enhance the heat dissipation performance to the ambient gaseous or liquid environment, which could also further reduce the eddy loss and temperature generated from iron core magnetic leakage with current-blocking function of the eddy-current blocking structure (1120) which located on at least one of the top surface, the front surfaces, the left surface, the right surface, the rear surfaces and bottom surface.

Wherein the eddy-current blocking structure including at least one perforated slots or long grooves arrayed in longitudinal (Y-Y), at least one perforated slots or long grooves in inclined longitudinal (Y-Y) orientation as illustrated in FIG. 73 to FIG.76

As shown in aforementioned FIG. 39 to FIG. 41, the embodiment utilizes the transversal (X-X) semi bridge-type heat dissipation fin (104) to increase the external heat dissipation and with the adjacent transversal (X-X) jointly-formed heat dissipation holes (111) for direct heat dissipation by the surface of iron core. However, while the transversal (X-X) semi-bridge-type heat dissipation fin (104) is not utilized under spatial consideration, and the external frame device is made by good electrical conducting material, under some operating status such as temporary overloading operation, the iron core magnetic leakage will induce eddy-current heat loss on the frame device cladding the iron-core. For reducing the eddy-current heat loss, the external frame could further fabricate with eddy-current blocking structure which composed by transversal (X-X) oriented perforated slots or long grooves, so that the capability of heat dissipation to the ambient gaseous or liquid environment can still be enhanced.

FIG. 77 is a front view showing the frame device (200) wherein at least one surface of the frame device is being formed with at least one transversal (X-X) or inclined transversal (X-X) arranged eddy-current blocking structure (1110) which consist of at least one perforated slot or long groove fabricate in transversal (X-X) or inclined transversal (X-X) orientation according to a twenty second embodiment of the present invention.

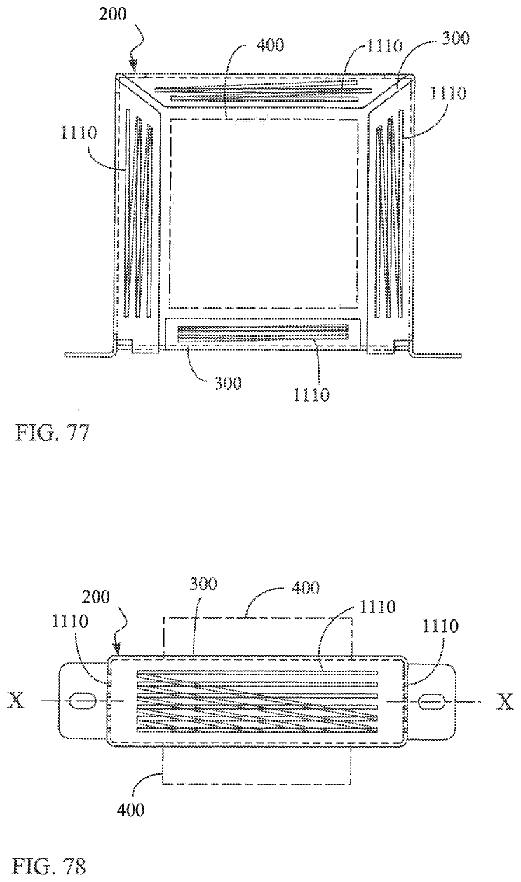

FIG. 78 is a top view of FIG. 77.

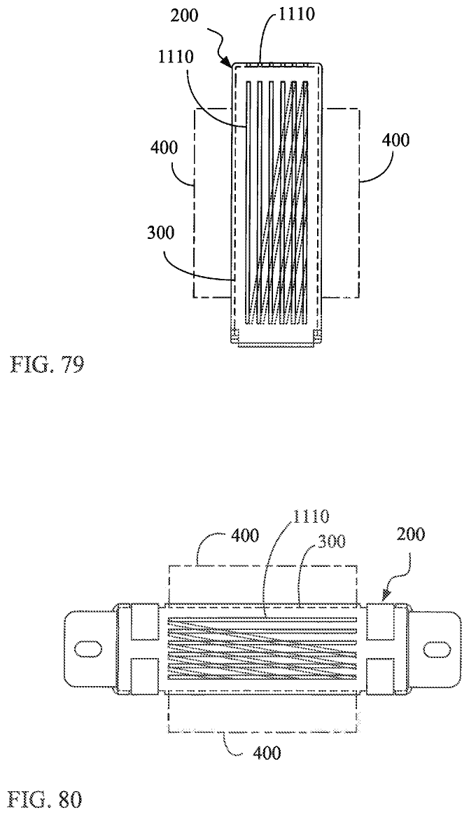

FIG. 79 is a side view of FIG. 77.

FIG. 80 is a bottom view of FIG. 77.

As shown from FIG. 77 to FIG. 80, take the frame device (200) disposed at the outer periphery of the iron core, structured by the iron core with the magnetic loops (300) formed as the square-like member or the rectangular member, of the static electrical machine as an example, the characteristic is that at least one of the top surface, the front surfaces, the left surface, the right surface, the rear surfaces and bottom surface of the frame device (200) is formed with at least one transversal (X-X) or inclined transversal (X-X) eddy-current blocking structure (1110) which consist of at least one perforated slots or long grooves, in addition to enhance the heat dissipation performance to the ambient gaseous or liquid environment, which could also further reduce the eddy loss and temperature generated from iron core magnetic leakage with current-blocking function of the eddy-current blocking structure (1110) which located on at least one of the top surface, the front surfaces, the left surface, the right surface, the rear surfaces and bottom surface.

Wherein the eddy-current blocking structure including at least one perforated slots or long grooves arrayed in transversal (X-X), at least one perforated slots or long grooves in inclined transversal (X-X) orientation as illustrated in FIG. 77 to FIG. 80,

According to the present invention, the application of the frame device of iron core of static electrical machine having outwardly-extended heat dissipation fin and/or heat dissipation hole includes the frame device of the iron core of the static electrical machine having the outwardly-extended heat dissipation fin and/or the heat dissipation hole and made of a thermal conductive material being served to clamp and fasten a winding structure consisted of a coil winding set, a BOBBIN, conducting pins and leading wires or a static electrical machine and consisted of an iron core with magnetic loops and installed in a gaseous or a liquid working environment, such as a transformer, an inductor, an electromagnet or a linear displacing actuator adopting the electromagnetic effect, or a device adopting the electromagnetic effect such as a device capable of converting kinetic energy generated via linear and reciprocal displacements into electric energy for power generation, so that the static electrical machine with the frame device of the iron core is outwardly-extended with the heat dissipation fin and/or the heat dissipation hole, thereby enlarging the heat dissipation area to the gaseous or liquid environment and further enhancing the heat dissipation performance thereof.

Based on what has been disclosed above, advantages achieved by the frame device of iron core of static electrical machine having outwardly-extended heat dissipation fin and/or heat dissipation hole provided by the present invention are as followings: the frame device is formed with the outwardly-extended heat dissipation fin structure, and/or the jointly-formed heat dissipation hole arranged on the adjacent surfaces between the frame device and the iron core with the magnetic loops and/or the heat dissipation hole, thus the heat dissipation area, directly exposed to the gaseous or liquid environment, of the iron core with the magnetic loops of the static electrical machine can be enlarged; and moreover, the outwardly-extended heat dissipation fin structure can be served to enlarge the heat dissipation area to the exterior, thereby allowing the heat dissipation performance of the iron core with the magnetic loops, clamped and fastened by the frame device, to the gaseous or liquid environment to be farther enhanced.

1. A frame device of iron core of static electrical machine having outwardly-extended heat dissipation fin and/or heat dissipation hole, within the frame device is formed with an outwardly-extended heat dissipation fin structure and/or formed with heat dissipation holes at locations defined on adjacent surfaces between the frame device and the iron core with the magnetic loops, so that the heat dissipation hole can be served to enlarge the heat dissipation area, directly exposed to an ambient gaseous or liquid environment, of the iron core with the magnetic loops of the static electrical machine, and the outwardly-extended heat dissipation fin can be served to enlarge the heat dissipation area to the exterior, thereby allowing the heat dissipation performance of the iron core with the magnetic loops, clamped and fastened by the frame device, to the ambient gaseous or liquid environment to be further enhanced;
the characteristic is that the frame device (200) formed with the outwardly-extended heat dissipation fin and/or the heat dissipation hole (300) allowing heat to the directly dissipate to the exterior is able to configure an optimized structure for enhancing the heat transferring performance of the iron core with the magnetic loops (300) to the ambient gaseous or liquid environment, wherein:
the outwardly-extended heat dissipation fin and the heat dissipation hole includes one or more than one of the followings:
(1) transversal (X-X) bridge-type heat dissipation fin (101);
(2) longitudinal (Y-Y) bridge-type heat dissipation fin (102);
(3) outwardly-bent-from-outer-edge heat dissipation fin (103);
(4) transversal (X-X) semi-bridge-type heat dissipation fin (104);
(5) longitudinal (Y-Y) semi-bridge-type heat dissipation fin (105);
(6) inclined bridge-type heat dissipation fin (106);
(7) V-shaped bridge-type heat dissipation fin (107);
(8) transversal (X-X) jointly-formed heat dissipation hole (111);
(9) longitudinal (Y-Y) jointly-formed heat dissipation hole (112);
(10) inclined jointly-formed heat dissipation hole (116);
(11) V-shaped jointly-formed heat dissipation hole (117); and
(12) heat dissipation hole (130) formed on the adjacent surfaces between the frame device (200) and the iron core with the magnetic loops (300) and allowing the iron core with the magnetic loops (300) to directly dissipate heat to the exterior.

2. A frame device of iron core of static electrical machine having outwardly-extended heat dissipation fin and/or heat dissipation hole as claimed in claim 1, further including for clamping and fastening the iron core with the magnetic loops (300) formed as the square-like member or the rectangular member, the locations where the outwardly-extended heat dissipation fins and/or the heat dissipation holes (130) being desirably formed are at least one of the locations defined on the top surface, the front surfaces, the left surface, the right surface, the rear surfaces and bottom surface A, B, C, D, E, F, G, H, I, J, K, L, which are defined as the surfaces of the frame device (200) served to clamp and fasten the iron core with the magnetic loops (300).

3. A frame device of iron core of static electrical machine having outwardly-extended heat dissipation fin and/or heat dissipation hole as claimed in claim 1 or 2, further including a frame device (200) disposed at the outer periphery of the iron core, structured by the iron core with the magnetic loops (300) formed as the square-like member or the rectangular member, of the static electrical machine, the characteristic is that at least one of the top surface, the front surfaces, the left surface, the right surface, the rear surfaces and bottom surface of the frame device (200) is formed with the at least one transversal (X-X) bridge-type heat dissipation fin (101) and the adjacent transversal (X-X) jointly-formed heat dissipation hole (111), so that the heat dissipation performance to the ambient gaseous or liquid environment can be enhanced.

4. A frame device of iron core of static electrical machine having outwardly-extended heat dissipation fin and/or heat dissipation hole as claimed in claim 1 or 2, further including a frame device (200) disposed at the outer periphery of the iron core, structured by the iron core with the magnetic loops (300) formed as the square-like member or the rectangular member, of the static electrical machine, the characteristic is that at least one of the top surface, the front surfaces, the left surface, the right surface, the rear surfaces and bottom surface of the frame device (200) is formed the at least one longitudinal (Y-Y) bridge-type heat dissipation fin (10.2) and the adjacent longitudinal (Y-Y) jointly-formed heat dissipation hole (112), so that the heat dissipation performance to the ambient gaseous or liquid environment can be enhanced,

5. A frame device of iron core of static electrical machine having outwardly-extended heat dissipation fin and/or heat dissipation hole as claimed in claim I or 2, further including a frame device (200) disposed at the outer periphery of the iron core, structured by the iron core with the magnetic loops (300) formed as the square-like member or the rectangular member, of the static electrical machine, the characteristic is that at least one of the top surface, the front surfaces, the loft surface, the right surface, the rear surfaces and bottom surface of the frame device (200) is formed with a plurality of the transversal (X-X) bridge-type heat dissipation fins (101) and the adjacent transversal (X-X) jointly-formed heat dissipation holes (111), so that the heat dissipation performance to the ambient gaseous or liquid environment can be enhanced.

6. A frame device of iron core of static electrical machine having outwardly-extended heat dissipation fin and/or heat dissipation hole as claimed in claim 1 or 2, further including a frame device (200) disposed at the outer periphery of the iron core, structured by the iron core with the magnetic loops (300) formed as the square-like member or the rectangular member, of the static electrical machine, the characteristic is that at least one of the top surface, the front surfaces, the left surface, the right surface, the rear surfaces and bottom surface of the frame device (200) is formed with a plurality of the longitudinal (Y-Y) bridge-type heat dissipation fins (102) and the adjacent longitudinal (Y-Y) jointly-formed heat dissipation holes (112), so that the heat dissipation performance to the ambient gaseous or liquid environment can be enhanced.

7. A frame device of iron core of static electrical machine having outwardly-extended heat dissipation fin and/or heat dissipation hole as claimed in claim 1 or 2, further including a frame device (200) disposed at the outer periphery of the iron core, structured by the iron core with the magnetic loops (300) formed as the square-like member or the rectangular member, of the static electrical machine, the characteristic is that at least one of the top surface, the front surfaces, the left surface, the right surface, the rear surfaces and bottom surface of the frame device (200) is farmed with the transversal (X-X) bridge-type heat dissipation fins (101) and the adjacent transversal (X-X) jointly-formed heat dissipation holes (ill), and the transversal (X-X) bridge-type heat dissipation fins (101) are respectively formed with the at least one flow discharging hole (120), so that the heat dissipation performance to the ambient gaseous or liquid environment can be enhanced.

8. A frame device of iron core of static electrical machine having outwardly-extended heat dissipation fin and/or heat dissipation hole as claimed in claim 1 or 2, further including a frame device (200) disposed at the outer periphery of the iron core, structured by the iron core with the magnetic loops (300) formed as the square-like member or the rectangular member, of the static electrical machine, the characteristic is that at least one of the top surface, the front surfaces, the left surface, the right surface, the rear surfaces and bottom surface of the frame device (200) is formed with the longitudinal (Y-Y) bridge-type heat dissipation fins (102) and the adjacent longitudinal (Y-Y) jointly-formed heat dissipation holes (112), and the longitudinal (Y-Y) bridge-type heat dissipation fins (102) are respectively formed with the at least one flow discharging hole (120), so that the heat dissipation performance to the ambient gaseous or liquid environment can be enhanced.

9. A frame device of iron core of static electrical machine having outwardly-extended heat dissipation fin and/or heat dissipation hole as claimed in claim I or 2, further including a frame device (200) disposed at the outer periphery of the iron core, structured by the iron core with the magnetic loops (300) formed as the square-like member or the rectangular member, of the static electrical machine, the characteristic is that at least one of the top surface, the front surfaces, the left surface, the right surface, the rear surfaces and bottom surface of the frame device (200) is formed with the at least one inclined bridge-type heat dissipation fin (106) and the adjacent inclined jointly-formed heat dissipation hole (116), so that the heat dissipation performance to the ambient gaseous or liquid environment can be enhanced.

10. A frame device of iron core of static electrical machine having outwardly-extended heat dissipation fin and/or heat dissipation hole as claimed in claim 1 or 2, further including a frame device (200) disposed at the outer periphery of the iron core, structured by the iron core with the magnetic loops (300) formed as the square-like member or the rectangular member, of the static electrical machine, the characteristic is that at least one of the top surface, the front surfaces, the left surface, the right surface, the rear surfaces and bottom surface is formed of the frame device (200) with the at least one V-shaped bridge-type heat dissipation fin (107) and the adjacent V-shaped jointly-formed heat dissipation hole (117), so that the heat dissipation performance to the ambient gaseous or liquid environment can be enhanced.

11. A frame device of iron core of static electrical machine having outwardly-extended heat dissipation fin and/or heat dissipation hole as claimed in claim 1 or 2, further including a frame device (200) disposed at the outer periphery of the iron core, structured by the iron core with the magnetic loops (300) formed as the square-like member or the rectangular member, of the static-electrical machine, the characteristic is that at least one of the top surface, the front surfaces, the left surface, the right surface, the rear surfaces and bottom surface of the frame device (200) is formed with the plural transversal (X-X) semi-bridge-type heat dissipation fins (104) and the adjacent transversal (X-X) jointly-formed heat dissipation holes (111), and the adjacent transversal (X-X) semi-bridge-type heat dissipation fins (104) are arranged at the same side, so that the heat dissipation performance to the ambient gaseous or liquid environment can be enhanced.

12. A frame device of iron core of static electrical machine having outwardly-extended heat dissipation fin and/or heat dissipation hole as claimed in claim 1 or 2, further including a frame device (200) disposed at the outer periphery of the iron core, structured by the iron core with the magnetic loops (300) formed as the square-like member or the rectangular member, of the static electrical machine, the characteristic is that at least one of the top surface, the front surfaces, the left surface, the right surface, the rear surfaces and bottom surface of the frame device (200) is formed with the plural transversal (X-X) semi-bridge-type heat dissipation fins (104) and the adjacent transversal (X-X) jointly-formed heat dissipation holes (111), and the adjacent transversal (X-X) semi-bridge-type heat dissipation fins (104) are staggeringly arranged at different sides, so that the heat dissipation performance to the ambient gaseous or liquid environment can be enhanced.

13. A frame device of iron core of static electrical machine having outwardly-extended heat dissipation fin and/or heat dissipation hole as claimed in claim 1 or 2, further including a frame device (200) disposed at the outer periphery of the iron core, structured by the iron core with the magnetic loops (300) formed as the square-like member or the rectangular member, of the static electrical machine, the characteristic is that at least one of the top surface, the front surfaces, the left surface, the right surface, the rear surfaces and bottom surface of the frame device (200) is formed with the at least one transversal (X-X) semi-bridge-type heat dissipation fin (104) arranged at the same side and as multiple rows and the adjacent transversal (X-X) jointly-formed heat dissipation hole (111), so that the heat dissipation performance to the ambient gaseous or liquid environment can be enhanced.

14. A frame device of iron core of static electrical machine having outwardly-extended heat dissipation fin and/or heat dissipation hole as claimed in claim 1 or 2, further including a frame device (200) disposed at the outer periphery of the iron core, structured by the iron core with the magnetic loops (300) formed as the square-like member or the rectangular member, of the static electrical machine, the characteristic is that at least one of the top surface, the front surfaces, the left surface, the right surface, the rear surfaces and bottom surface of the frame device (200) is formed with the at least one transversal (X-X) semi-bridge-type heat dissipation fin (104) arranged at different sides and as multiple rows and the adjacent transversal (X-X) jointly-formed heat dissipation hole (111), so that the heat dissipation performance to the ambient gaseous or liquid environment can be enhanced.

15. A frame device of iron core of static electrical machine having outwardly-extended heat dissipation fin and/or heat dissipation hole as claimed in claim 1 or 2, further including a frame device (200) disposed at the outer periphery of the iron core, structured by the iron core with the magnetic loops (300) formed as the square-like member or the rectangular member, of the static electrical machine, the characteristic is that at least one of the outer edges of the adjacent surfaces between the frame device (200) and the iron core of the static electrical machine, which are the top surface, the front surfaces, the left surface, the right surface, the rear surfaces and bottom surface, is formed with the outwardly-bent-from-outer-edge heat dissipation fin (103), so that the heat dissipation performance to the ambient gaseous or liquid environment can be enhanced.

16. A frame device of iron core of static electrical machine having outwardly-extended heat dissipation fin and/or heat dissipation hole as claimed in claim 1 or 2, further including a frame device (200) disposed at the outer periphery of the iron core, structured by the iron core with the magnetic loops (300) formed as the square-like member or the rectangular member, of the static electrical machine, the characteristic is that at least one of the outer edges of the adjacent surfaces between the frame device (200) and the iron core of the static electrical machine, which are the top surface, the front surfaces, the left surface, the right surface, the rear surfaces and bottom surface, is formed with the outwardly-bent-from-outer-edge heat dissipation fin (103) in the multi-bending structural status for further increasing the heat dissipation area, so that the heat dissipation performance to the ambient gaseous or liquid environment can be enhanced.

17. A frame device of iron core of static electrical machine having outwardly-extended heat dissipation fin and/or heat dissipation hole as claimed in claim 1 or 2, further including a frame device (200) disposed at the outer periphery of the iron core, structured by the iron core with the magnetic loops (300) formed as the square-like member or the rectangular member, of the static electrical machine, the characteristic is that at least one of the top surface, the front surfaces, the left surface, the right surface, the rear surfaces and bottom surface of the frame device (200) is formed with the longitudinal (Y-Y) bridge-type heat dissipation fins (102) and the adjacent longitudinal (Y-Y) jointly-formed heat dissipation holes (112), and at least one of the outer edges of the adjacent surfaces between the frame device (200) and the iron core of the static electrical machine, which are top surface, the front surfaces, the left surface, the right surface, the rear surfaces and bottom surface, is formed with the outwardly-bent-from-outer-edge heat dissipation fin (103) in the multi-bending structural status for further increasing the heat dissipation area, so that the heat dissipation performance to the ambient gaseous or liquid environment can be enhanced.

18. A frame device of iron core of static electrical machine having outwardly-extended heat dissipation fin and/or heat dissipation hole as claimed in claim 1 or 2, further including a frame device (200) disposed at the outer periphery of the iron core, structured by the iron core with the magnetic loops (300) formed as the square-like member or the rectangular member, of the static electrical machine, the characteristic is that at least one of the top surface, the front surfaces, the left surface, the right surface, the rear surfaces and bottom surface of the frame device (200) is formed with the longitudinal (Y-Y) bridge-type heat dissipation fins (102) and the adjacent longitudinal (Y-Y) jointly-formed heat dissipation holes (112), the longitudinal (Y-Y) bridge-type heat dissipation fins (102) are respectively formed with the at least one flow discharging hole (120), and at least one of the outer edges of the adjacent surfaces between the frame device (200) and the iron core of the static electrical machine, which are top surface, the front surfaces, the left surface, the right surface, the rear surfaces and bottom surface, is formed with the outwardly-bent-from-outer-edge heat dissipation fin (103) in the multi-bending structural status for further increasing the heat dissipation area, so that the heat dissipation performance to the ambient gaseous or liquid environment can be enhanced.

19. A frame device of iron core of static electrical machine having outwardly-extended heat dissipation fin and/or heat dissipation hole as claimed in claim 1 or 2, further including, a frame device (200) disposed at the outer periphery of the iron core, structured by the iron core with the magnetic loops (300) formed as the square-like member or the rectangular member, of the static electrical machine, the characteristic is that at least one of the adjacent surfaces between the frame device (200) of the iron core of the static electrical machine, which are the top surface, the front surface, the left surface, the right surface, the rear surface and bottom surface, and the iron core with the magnetic loops (300) is formed with the rectangular heat dissipation hole (130) allowing the iron core with the magnetic loops (300) to directly dissipate heat to the exterior, so that the heat dissipation performance to the ambient gaseous or liquid environment can be enhanced.

20. A frame device of iron core of static electrical machine having outwardly-extended heat dissipation fin and/or heat dissipation hole as claimed in claim 1 or 2, further including a frame device (200) disposed at the outer periphery of the iron core, structured by the iron core with the magnetic loops (300) formed as the square-like member or the rectangular member, of the static electrical machine, the characteristic is that the frame device (200) is formed with the transversal (X-X) bridge-type heat dissipation fins (101) and the adjacent transversal (X-X) jointly-formed heat dissipation holes (111), the transversal (X-X) bridge-type heat dissipation fins (101) are respectively formed with the at least one flow discharging hole (120), and the adjacent surfaces between the frame device (200) and the iron with the magnetic loops (300) are formed with the heat dissipation hole (130) allowing the iron core with the magnetic loops (300) to directly dissipate heat to the exterior, so that the heat dissipation performance to the ambient gaseous or liquid environment can be enhanced.

21. A frame device of iron core of static electrical machine having outwardly-extended heat dissipation fin and/or heat dissipation hole as claimed in claim 1 or 2, further including a frame device (200) disposed at the outer periphery of the iron core, structured by the iron core with the magnetic loops (300) formed as the square-like member or the rectangular member, of the static electrical machine, the characteristic is that the frame device (200) is formed with the longitudinal (Y-Y) bridge-type heat dissipation fins (102) and the adjacent longitudinal (Y-Y) jointly-formed heat dissipation holes (112), the longitudinal (Y-Y) bridge-type heat dissipation fins (102) are respectively formed with the at least one flow discharging hole (120), and the adjacent surfaces between the frame device (200) and the iron with the magnetic loops (300) are formed with the heat dissipation hole (130) allowing the iron core with the magnetic loops (300) to directly dissipate heat to the exterior, so that the heat dissipation performance to the ambient gaseous or liquid environment can be enhanced.

22. A frame device of iron core of static electrical machine having outwardly-extended heat dissipation fin and/or heat dissipation hole as claimed in claim 1 or 2, further including a frame device (200) disposed at the outer periphery of the iron core, structured by the iron core with the magnetic loops (300) formed as the square-like member or the rectangular member, of the static electrical machine, the characteristic is that the frame device (200) is formed with the at least one transversal (X-X) semi-bridge-type heat dissipation fin (104) and the adjacent transversal (X-X) jointly-formed heat dissipation hole (111), and the adjacent surfaces between the frame device (200) and the iron with the magnetic loops (300) are formed with the heat dissipation hole (130) allowing the iron core with the magnetic loops (300) to directly dissipate heat to the exterior, so that the heat dissipation performance to the ambient gaseous or liquid environment can be enhanced.

23. A frame device of iron core of static electrical machine having outwardly-extended heat dissipation fin and/or heat dissipation hole as claimed in claim 1 or 2, further including a frame device (200) disposed at the outer periphery of the iron core, structured by the iron core with the magnetic loops (300) formed as the square-like member or the rectangular member, of the static electrical machine, the characteristic is that the frame device (200) is formed with the at least one longitudinal (Y-Y) semi-bridge-type heat dissipation fin (105) and the adjacent longitudinal (Y-Y) jointly-formed heat dissipation hole (112), and the adjacent surfaces between the frame device (200) and the iron with the magnetic loops (300) are formed with the heat dissipation hole (130) in the rectangular slot-like status and allowing the iron core with the magnetic loops (300) to directly dissipate heat to the exterior, so that the heat dissipation performance to the ambient gaseous or liquid environment can be enhanced.

24. A frame device of iron core of static electrical machine having outwardly-extended heat dissipation fin and/or heat dissipation hole as claimed in claim 1 or 2, further including a frame device (200) is composed by good electrical conducting material and doesn't install the longitudinal (Y-Y) semi-bridge-type heat dissipation fin (105) due to spatial consideration, under specific operating status such as temporary overloading operation, the iron core leakage will induce eddy-current heat loss on the external frame device cladding the iron-core. For reducing the eddy-current heat loss, the external frame could further fabricate with eddy-current blocking structure which composed by longitudinal (Y-Y) oriented seams or long slots, so that the heat dissipation performance to the ambient gaseous or liquid environment can be enhanced;
the characteristic is that at least one of the top surface, the front surfaces, the left surface, the right surface, the rear surfaces and bottom surface of the frame device (200) is formed with at least one longitudinal (Y-Y) or inclined longitudinal (Y-Y) eddy-current blocking structure (1120) which consist of at least one perforated slots or long grooves, in addition to enhance the heat dissipation performance to the ambient gaseous or liquid environment, which could also further reduce the eddy loss and temperature generated from iron core magnetic leakage with current-blocking function of the eddy-current blocking structure (1120) which located on at least one of the top surface, the front surfaces, the left surface, the right surface, the rear surfaces and bottom surface;
wherein the eddy-current blocking structure including at least one perforated slots or long grooves arrayed in longitudinal (Y-Y), at least one perforated slots or long grooves in inclined longitudinal (Y-Y) orientation.

25. A frame device of iron core of static electrical machine having outwardly-extended heat dissipation fin and/or heat dissipation hole as claimed in claim 1 or 2, further including a frame device (200) is composed by good electrical conducting material and doesn't install the transversal (X-X) semi-bridge-type heat dissipation fin (104) due to spatial consideration, under specific operating status such as temporary overloading operation, the iron core leakage will induce eddy-current heat loss on the frame device cladding the iron-core. For reducing the eddy-current heat loss, the external frame could further fabricate with eddy-current blocking structure which composed by transversal (X-X) oriented perforated slots or long grooves, so that the heat dissipation performance to the ambient gaseous or liquid environment can still be enhanced;
the characteristic is that at least one of the top surface, the front surfaces, the left surface, the right surface, the rear surfaces and bottom surface of the frame device (200) is formed with at least one transversal (X-X) or inclined transversal (X-X) eddy-current blocking structure (1110) which consist of at least one perforated slots or long grooves, in addition to enhance the heat dissipation performance to the ambient gaseous or liquid environment, which could also further reduce the eddy loss and temperature generated from iron core magnetic leakage with current-blocking function of the eddy-current blocking structure (1110) which located on at least one of the top surface, the front surfaces, the left surface, the right surface, the rear surfaces and bottom surface;
wherein the eddy-current blocking structure including at least one perforated slots or long grooves arrayed in transversal (X-X), at least one perforated slots or long grooves in inclined transversal (X-X) orientation.

26. A frame device of iron core of static electrical machine having outwardly-extended heat dissipation fin and/or heat dissipation hole as claimed in claim 1 or 2, within the application including the frame device of the iron core of the static electrical machine having the outwardly-extended heat dissipation fin and/or the heat dissipation hole and made of a thermal conductive material being served to clamp and fasten a winding structure consisted of a coil winding set, a BOBBIN, conducting pins and leading wires or a static electrical machine and consisted of an iron core with magnetic loops and installed in a gaseous or a liquid working environment, such as a transformer, an inductor, an electromagnet or a linear displacing actuator adopting the electromagnetic effect, or a device adopting the electromagnetic effect such as a device capable of converting kinetic energy generated via linear and reciprocal displacements into electric energy for power generation, so that the static electrical machine with the frame device of the iron core is outwardly-extended with the heat dissipation fin and/or the heat dissipation hole, thereby enlarging the heat dissipation area to the gaseous or liquid environment and further enhancing the heat dissipation performance thereof.
